(19) United States
(12) Patent Application Publication
(10) Pub. No.: US 2008/0120396 A1
(43) Pub. Date: May 22, 2008

(54) Personal contact and marketing system

(76) Inventors: Nandagopal Mysore Jayaram, Mason, OH (US); Michael Jay Halloran, Cincinnati, OH (US); Sameer Mungur, Cincinnati, OH (US); Jaydev Karande, Cincinnati, OH (US); Jona Hyun, Cincinnati, OH (US); Gerard Edward Sychay, Cincinnati, OH (US)

Correspondence Address: Mark F. Smith, 905 Ohio Pike, Cincinnati, OH, 45245, US

(21) Appl. No.: 11/603,735

(22) Filed: Nov. 22, 2006

(51) Int. Cl. G06F 15/16

(52) U.S. Cl. 709/218

(57) ABSTRACT

The method and system hereof is for a computer-aided personal contact and marketing system that operates to provide a collaborative personal contact network whereby individuals can participate and which allows businesses and organizations to communicate with select individuals within the network thereby optimizing their marekting efforts. Preferably, the method and system utilizes at least one Internet web-site having a plurality of web-pages providing an interactive, menu and event driven system that cooperates with a system server for using prompt, dialog, and entry windows to guide a user to enter and/or obtain information.

### COPYRIGHT NOTIFICATION

Portions of this patent application contain materials that are subject to copyright protection. The copyright owner has no objection to the facsimile reproduction by anyone of the patent document or the patent disclosure, as it appears in the Patent and Trademark Office patent file or records. The copyright owner, however, otherwise reserves all copyright rights whatsoever.

### BACKGROUND OF THE INVENTION

The present invention relates to computer-aided personal contact and marketing system, and more particularly to an interactive software method and system that provides a collaborative process in which individuals can participate in a personal contact network and which allows businesses and organizational clients to communicate with select individuals within the system community thereby optimizing their marketing efforts.

The interconnectivity of individuals and organizations has increased significantly in recent years with advent of various telecommunication means, including the Internet. The Internet has connected people, businesses, and organizations through various means that include online bulletin boards, email, and online instant messaging. The very success of the Internet has however created problems. Users often prefer to control his/her Internet visibility and accessibility to a specific community of friends, businesses, and organizations that are of interest to that user.

Personal and business decisions are often directly or indirectly affected by the preferences, tastes and actions of one's friends, colleagues and acquaintances. Further, an individual's choice is also influenced by available information provided to them through various sources. Additionally, a recommendation, or an adverse comment from a close trusted acquaintance regarding a specific activity will often override other factors in an individual's decision.

Individuals today are often confronted with a daily surplus of social information that competes for the individual's attention in almost every aspect of their work, recreation, and social lives. A popular form of advertising on large private networks or public networks, such as the Internet, is through the use of electronic mail. In a typical scenario, companies purchase or collate lists of user email addresses and then send unsolicited commercial messages, such as advertisements, announcements, etc., to those users. Commonly known as “spam” orelectronicjunk mail, these messages often relate to goods or services which the recipient doesn't want or need. The response rate to these types of unsolicited messages is extremely low, typically less than one-tenth of one percent and the vast majority of the messages are deleted without even being read. In addition, because of the volume of unsolicited messages received by a typical party, there is a high likelihood that the recipient will become biased against the sponsor of the message because of the unwelcome method of delivery, even if they might otherwise be interested in the subject matter. Further, advertisements in the form of mailers, fliers, and the like are often simply ignored or the information is discarded before even having reviewed it. In contrast, individuals generally are in frequent contact with friends and acquaintances with regard to films, entertainment, clubs, restaurants, and the like and a recommendation by a trusted friend is typically given far greater weight and consideration and will often be accorded far greater significance than any number of expensive, professionally produced, and theoretically compelling advertisements or recommendations.

Nevertheless, because the Internet can provide individuals directly with advertisements, businesses often utilize the Internet as a medium for advertising. While the Internet is a relatively inexpensive way to directly supply individuals with advertisements and information, advertisers are looking for ways of reaching users more effectively with advertisements for the products and services without the drawbacks discussed above. One approach to the problem of general broad advertising that has been developed is to target messages to particular individuals according to their interests by allowing individuals to “subscribe” to particular mailing lists in advance. In a typical situation, an individual accesses an Internet web-page which provides a list of various subject categories. The individuals then subscribe to one or more categories that interest them and provide their email address and various types of demographic information. The premise behind this approach is that the listed addresses represent individuals who have taken the affirmative step of voluntarily signing up to receive commercial email about topics of interest, and thus the response rate should be greater than completely unsolicited email. However, this premise is only somewhat correct. In practice, a certain percentage of subscriptions are not made by the listed party, but rather result from the action of third parties. Thus, when a company uses a given subscription list to target commercial messages, many of the recipients will consider the messages to be unsolicited advertisements, resulting in the generation of bad-will toward the company. Even if the recipient is provided with the option of having them removed from the mailing list, this option is not available until after the fact, and so is relatively ineffective in preventing at least some unsolicited messages from being sent. In addition, individuals are routinely required to search out specific web-pages and fill out a subscription or information form for each business or organization they are interested in receiving information from.

Accordingly, what is needed is a computer-aided personal contact and marketing system that provides a collaborative process in which individuals can participate in a personal contact network and which allows businesses and organizational clients to communicate with select individuals within the network without the drawbacks of attributed to unsolicited advertisements thereby optimizing their marketing efforts and effectiveness.

### SUMMARY OF THE INVENTION

The current invention is a system for implementing a community, preferably an Internet community, that provides users with a private personal network formed by various individuals and selected contacts known to the individuals, either directly or indirectly, to form communities and allows those in that community to interact to create and coordinate personalized calendars; plan, organize, and communicate events and activities; review and comment and obtain information pertaining to venues and events; coordinate social activities with other members; and share information, photographs, thoughts, and the like with other members of the community. The system further provides an individual with means for receiving information from specific businesses that have been identified by the individual as being of interest.

In a preferred embodiment of the invention the personal contact and marketing system provides a method whereby each individual member stores within the system personal information and is provided with a calendar allowing the individual to schedule activities and events.

In another preferred embodiment of the invention the personal contact and marketing system provides means for individual members to form communities and communicate with other individuals within the community.

In another preferred embodiment of the invention the personal contact and marketing system provides means for individual members to invite other individual members within the community to participate in a social activity.

In another preferred embodiment of the invention the personal contact and marketing system provides means for individuals to acknowledge their intent to participate in a social activity.

In another preferred embodiment of the invention the personal contact and marketing system provides individual members with means for creating personal profiles for view by other individual members within their community or within the network.

In another preferred embodiment of the invention the personal contact and marketing system provides means for allowing individual members to invite other individuals into the community.

In another preferred embodiment of the invention the personal contact and marketing system provides means for allowing an individual member to create a neighborhood of “friends” within the community.

In another preferred embodiment of the invention the personal contact and marketing system provides means for allowing an individual member to add or subtract individual members from his/her neighborhood of friends.

In another preferred embodiment of the invention the personal contact and marketing system provides means for allowing an individual member to search for other individual members within the community and invite the individual member into his/her neighborhood of friends.

In another preferred embodiment of the invention the personal contact and marketing system provides means for allowing an individual member to communicate and exchange comments, photographs, and the like with other individual members within the community.

In another preferred embodiment of the invention the personal contact and marketing system provides means for allowing an individual member to identify specific venues that the individual member is interested in receiving information concerning the venue, events or offers made by the venue.

In another preferred embodiment of the invention the personal contact and marketing system provides means whereby events and offers that are of interest to an individual member are automatically listed on the individual member's calendar.

In another preferred embodiment of the invention the personal contact and marketing system provides means for allowing a business client to post venue, event, or offer information on the system.

In another preferred embodiment of the invention the personal contact and marketing system provides means for allowing a business client to send information to individual members identified as being interested in such information.

In another preferred embodiment of the invention the personal contact and marketing system provides means for allowing a business client to generally advertise.

In another preferred embodiment of the invention the personal contact and marketing system provides means for allowing a business client to advertise specific events, offers, and/or activities.

In another preferred embodiment of the invention the personal contact and marketing system provides means whereby event and offer information can be transmitted to individual members via a plurality of modems.

In another preferred embodiment of the invention the personal contact and marketing system provides means for allowing a business client to receive statistical analysis concerning members within the community who have interacted with said business client.

In another preferred embodiment of the invention the personal contact and marketing system provides means whereby business clients can create a calendar for marketing that can be linked to a business client's outside web-page, blog, and the like.

In another preferred embodiment of the invention the personal contact and marketing system provides business clients means whereby they can directly contact individuals concerning upcoming events and/or offers.

In another preferred embodiment of the invention the personal contact and marketing system provides means for allowing an individual member to purchase goods and event tickets from business clients.

In another preferred embodiment of the invention, the personal contact and marketing system comprises a computer system having a processor and a computer-readable medium having computer-readable instructions for performing a method of operating the system, wherein the computer is linked to more than one input/output device to permit users and business clients to communicate, and wherein the computer-readable medium when executed by the processor directs the processor to receive information and to transmit information in real-time to users and business clients.

In another preferred embodiment of the invention the personal contact and marketing system comprises means for storing the business client's information, means for storing individual member's information, and means for linking the means for storing the business client's information with the means for storing individual member's information together.

In another preferred embodiment of the invention the personal contact and marketing system comprises an interactive communications interface having an interactive calendar on which individual members can schedule activities.

In another preferred embodiment of the invention the personal contact and marketing system comprises an interactive communications interface having means for posting messages.

In another preferred embodiment of the invention the personal contact and marketing system comprises an interactive communications interface having means for instant messaging between individual members within a community.

In another preferred embodiment of the invention the personal contact and marketing system comprises means whereby individual users of one community can interact in other communities within the system.

These and other benefits, advantages, and embodiments of the invention will be apparent from the following description, the accompanying drawings and the appended claims.

### BRIEF DESCRIPTION OF THE DRAWINGS

Features, aspects, and advantages of the present invention will become better understood with regard to the following description, appended claims, and accompanying drawings where:

FIG. 1 is a schematic representation of a preferred embodiment of the personal contact and marketing system of the subject invention showing individual user computers, business/organization computers, at least one system server, and network interconnections linking the same together;

FIG. 2 is a schematic representation of a preferred individual user/member and business computer having an input device and an output device for connecting to the system server of the personal contact and marketing system of FIG. 1;

FIG. 3 is a schematic representation illustrating the general methodology and interactive method of the system software of the personal contact and marketing system;

FIG. 4 is a schematic representation showing method of registering a user to become a member of the personal contact and marketing system of the subject application;

FIG. 5 is an exemplary illustration of a representative opening web-page generated by the system software showing a “sign-up” field for becoming a member;

FIG. 6 is an exemplary illustration of a representative registration web-page generated by the system software of the personal contact and marketing system;

FIG. 7 is an exemplary illustration of a representative web-page generated by the system software of the personal contact and marketing system showing how a member can change his/her password;

FIG. 8 is an exemplary illustration of a representative web-page generated by the system software of the personal contact and marketing system showing how a member can change his/her Email address;

FIG. 9 is an exemplary illustration of a representative web-page generated by the system software of the personal contact and marketing system showing how a member can edit his/her profile;

FIG. 10 is an exemplary illustration of a representative home web-page generated by the system software of the personal contact and marketing system showing how a member can add photographs to be displayed on the member's profile;

FIG. 11 is an exemplary illustration of a representative home web-page generated by the system software of the personal contact and marketing system showing how a member can navigate to various features of the system using displayed fields;

FIG. 12 is a schematic representation showing the general methodology and method of selecting the “events” field of the personal contact and marketing system of the subject application;

FIG. 13 is an exemplary illustration of a representative web-page generated by the system software showing a drop-down listing of an “events” for selected venues and a search field for searching for events;

FIG. 14 is an exemplary illustration showing a detailed events web-page generated by the system software for a specific event identified in the drop-down list of FIG. 13 and selected by the user/member;

FIG. 15 is an exemplary illustration showing a web-page generated by the system software showing a drop-down listing of events that a member's “friend” has selected of being of interest;

FIG. 16 is an exemplary illustration showing a web-page generated by the system software showing how a member can create a personal event;

FIG. 17 is a schematic representation showing the general methodology and method of selecting the “venue” field of the personal contact and marketing system of the subject application;

FIG. 18 is an exemplary illustration of a representative venue drop-down list generated by the system software showing venues that were selected by the user/member of being of interest and showing a search “venue” field for venues;

FIG. 19 is a schematic representation showing the general methodology and method of selecting the “friends” field of the personal contact and marketing system of the subject application;

FIG. 20 is an exemplary illustration of a representative “friends” list generated by the system software showing a listing of “friends” identified by an individual member and showing a “search members” field for searching for other members within the network;

FIG. 21 is an exemplary illustration of a web-page generated by the system software showing how a member can create designated sub-groups of friends created from the member's friends list;

FIG. 22 is a schematic representation showing the general methodology and method of selecting the “message” field of the personal contact and marketing system of the subject application;

FIG. 23 is an exemplary illustration of a representative message list generated by the system software for an individual member showing a drop-down listing of messages and a search “message” field for messages;

FIG. 24 is an exemplary illustration of a web-page generated by the system software showing how a member can compose a personalized message to send to a “friend” or other party;

FIG. 25 is an exemplary illustration of a web-page generated by the system software showing how a member can input information necessary to receive SMS/text messages and Email alerts concerning special events and other information;

FIG. 26 is a schematic representation showing the general methodology and method of selecting the “offer” field of the personal contact and marketing system of the subject application;

FIG. 27 is an exemplary illustration of a web-page generated by the system software showing a representative drop-down offer list showing offers made by various venues;

FIG. 28 is a schematic representation showing the general methodology and method of reviewing and commenting on various blog articles;

FIG. 29 is an exemplary illustration of a web-page generated by the system software showing how a member can view blog articles posted by members in the community;

FIG. 30 is an exemplary illustration of a web-page generated by the system software showing how a member can comment on a particular blog article;

FIG. 31 is a schematic representation showing the general methodology and method of selecting the “photo” field of the personal contact and marketing system of the subject application;

FIG. 32 is an exemplary illustration of a web-page generated by the system software showing a representative drop-down photo list and showing fields for various photo albums stored in the photograph data bank;

FIG. 33 is another exemplary illustration of a web-page generated by the system software showing how a user/member can review a collection of photos in albums;

FIG. 34 is another exemplary illustration of a web-page generated by the system software showing how a member can create a photo album;

FIG. 35 is another exemplary illustration of a web-page generated by the system software showing how a member can upload photographs to be stored in the photograph data bank;

FIG. 36 is a schematic representation showing the general methodology and method of selecting the “contests” field of the personal contact and marketing system of the subject application;

FIG. 37 is an exemplary illustration of a web-page generated by the system software showing a representative drop-down list showing various contests being offered by the system administrators or by business venues;

FIG. 38 is another exemplary illustration of a web-page generated by the system software showing a detailed description of a contest;

FIG. 39 is another exemplary illustration of a web-page generated by the system software showing how a member can register, such as entering photographs, to enter a contest;

FIG. 40 is a schematic representation showing the general methodology and method of a business client of the system software providing a business administration portal on the business opening web-page and the “home” web-page comprising various field options;

FIG. 41 is an exemplary illustration of a representative opening web-page generated by the system software showing a business administration portal;

FIG. 42 is an exemplary illustration of a representative “home” web-page generated by the system software showing a preferred business calendar;

FIG. 43 is a schematic representation showing the general methodology and method of selecting the “edit profile” field of the personal contact and marketing system of the subject application;

FIG. 44 is an exemplary illustration of a representative “edit profile” web-page generated by the system software showing how a business client can edit information stored in the business profile data bank;

FIG. 45 is an exemplary illustration of a representative web-page generated by the system software showing how a business client can upload a photo into the business profile data bank;

FIG. 46 is an exemplary illustration of a representative web-page generated by the system software showing how a business client can enter hours of operation or edit same for storage, in the business profile data bank;

FIG. 47 is an exemplary illustration of a representative web-page generated by the system software showing how a business client can enter a Email address or edit same, for storage in the business profile data bank;

FIG. 48 is an exemplary illustration of a representative web-page generated by the system software showing how a business client can change a password for modifying a business account or edit same;

FIG. 49 is a schematic representation showing the general methodology and method of selecting the “manage events” field of the personal contact and marketing system of the subject application;

FIG. 50 is an exemplary illustration of a representative “manage events” web-page generated by the system software showing events previously entered by a business client and showing various fields for posting, deleting and adding events;

FIG. 51 is an exemplary illustration of a representative web-page generated by the system software showing how a business client can add events to be stored in the business information data bank;

FIG. 52 is an exemplary illustration of a representative web-page generated by the system software showing how a business client can add detailed event date/time information for an event to be stored in the business information data bank;

FIG. 53 is an exemplary illustration of a representative web-page generated by the system software showing how a business client can add detailed location event information for an event to be stored in the business information data bank;

FIG. 54 is a schematic representation showing the general methodology and method of selecting the “statistics” field of the personal contact and marketing system of the subject application;

FIG. 55 is an exemplary illustration of a representative statistics web-page generated by the system software displaying statistical information, such as subscriber growth over time data;

FIG. 56 is an exemplary illustration of a representative statistics web-page generated by the system software displaying statistical information, such as subscriber source data;

FIG. 57 is an exemplary illustration of a representative statistics web-page generated by the system software displaying statistical information, such as marketing effectiveness data;

FIG. 58 is an exemplary illustration of a representative statistics web-page generated by the system software displaying statistical demographic information, such as subscriber gender data;

FIG. 59 is an exemplary illustration of a representative statistics web-page generated by the system software displaying statistical demographic information, such as subscriber age data;

FIG. 60 is an exemplary illustration of a representative statistics web-page generated by the system software displaying statistical demographic information, such as member/user's other selected venues;

FIG. 61 is an exemplary illustration of a representative statistics web-page generated by the system software displaying statistical information, such as the number of “clicks” received for particular events or venues;

FIG. 62 is am exemplary illustration of a representative statistics web-page generated by the system software displaying statistical information, such as geographic location of user/members;

FIG. 63 is a schematic representation showing the general methodology and method of selecting the “Email uploads” field of the personal contact and marketing system of the subject application;

FIG. 64 is an exemplary illustration of a representative “Email uploads” web-page generated by the system software for inviting individuals to join the network;

FIG. 65 is a schematic representation showing the general methodology and method of selecting the “news” field of the personal contact and marketing system of the subject application;

FIG. 66 is an exemplary illustration of a representative “news” web-page generated by the system software showing information inputted by the system administrator to be distributed to business clients;

FIG. 67 is a schematic representation showing the general methodology and method of selecting the “web tool” field of the personal contact and marketing system of the subject application;

FIG. 68 is an exemplary illustration of a representative “web tool” web-page generated by the system software showing how a business client can modify the appearance of an album to be displayed on the business client's personal web page;

FIG. 69 is an exemplary illustration of a representative topic web-page generated by the system software showing how a business client can create a blog topic to be hosted and displayed by the system;

FIG. 70 is an exemplary illustration of a representative “manage blog articles” web-page generated by the system software showing how a business client can manage blog topics;

FIG. 71 is an exemplary illustration of a representative “blog customization” web-page generated by the system software showing how blog topics can be posted on a business client's personal web page;

FIG. 72 is an exemplary illustration of a representative “calendar customization” web-page generated by the system software showing how a business client can customize a business calendar that can be posted on the business client's personal web-page;

FIG. 73 is an exemplary illustration of a representative web-page generated by the system software showing how a business client can instruct the system software to generate computer code to enable calendar, blog, or photos to be posted on the business client's personal web-page;

FIG. 74 is a schematic representation showing the general methodology and method of selecting the “photo” field of the personal contact and marketing system of the subject application;

FIG. 75 is an exemplary illustration of a representative web-page generated by the system software showing how a business client can create an album of photographs;

FIG. 76 is an exemplary illustration of a representative web-page generated by the system software showing how a business client can edit a collection of photographs in an album;

FIG. 77 is an exemplary illustration of a representative web-page generated by the system software showing how a business client can upload one or more photographs albums into the business information data bank of the personal contact and marketing system of the subject application;

FIG. 78 is an exemplary illustration of a member identification means, such as a membership card as shown, that in another preferred embodiment operates to allow the individual member to participate in certain activities and functions within the network.

FIG. 79 is a schematic representation showing a “community” field allowing a user/member to participate or communicate with other communities, such as those operating in other cities or states; and

FIG. 80 is a schematic representation showing a general summary of the various aspects and interconnections between businesses and organizations and individual users/members provided by the personal contact and marketing system of the subject application.

### DETAILED DESCRIPTION OF THE PREFERRED EMBODIMENT

The present invention solves the prior art problems discussed above and provides a distinct advance in the state of the art. The personal contact and marketing system preferably is a computer-aided system that operates to provide a collaborative personal contact network whereby individuals can participate and which allows businesses and organizations to communicate with select individuals within the network thereby optimizing their marketing efforts. Preferably, the method and system utilizes at least one Internet web-site having a plurality of web-pages providing an interactive, menu and event driven system that cooperates with a system server for using conventional prompt, dialog, and entry windows to guide a user to enter and/or obtain information.

Preferably, the personal contact and marketing system of the present application provides a network comprising at least one localized community whereby individuals or users having a common link can become individual members and build a social neighborhood. It should be understood that the network can comprise one or more communities, such as communities operating primarily in other geographic locations. An individual member within a community that has formed a social neighborhood can identify and invite those individuals who are also members of the network to join the neighborhood and can also invite other nonmembers who use the network (“users”) to become individual members of the network and a community and participate in the member's social neighborhood. Preferably, individual members that are invited into and join a neighborhood each have a common link, such as being friends, have common friends, belong to common professional and/or social associations, have common interests, and the like. Also, it is preferred that individual members of various neighborhoods within the community can be cross-correlated by the system and which operates to identify individual members that share common friends thereby linking the neighborhoods together within the community. The system further provides means for developing, creating, storing, and updating a personal social calendar for each individual member. Preferably, individual members within a social neighborhood can review the calendars of other individual members within that social neighborhood. In addition, an individual member is permitted to interact with other individual member's social calendar such as by one individual member identifying social engagements or events of interest and requesting that the system operates to add the events or engagements into another's social calendar. Preferably, such notification can also be transmitted through various other channels and modals such as through instant messaging, chat rooms, bulletin boards, Blogs, Email, and other like means. Chat rooms, instant messaging, and bulletin boards offer each individual member the opportunity to communicate online with other individual members within a neighborhood or community. It should be understood that instant messaging operates similarly to a chat room and as soon as an individual member begins to enter information, the information appears on an output device of the computer of the recipient.

The personal contact and marketing system of the present invention also provides means whereby businesses and organizations, herein collectively referred to herein as “business or businesses,” can tap into a community or the entire network. Preferably, businesses that become “business clients,” such as by paying a fee to the system administrator, can tap into the network and the system operates to identify specific individuals within the network or a community who have indicated that they are interested in a specific business or who have identified themselves as being interested in a particular type of business. In a preferred embodiment of the invention, the system provides business clients with the ability of evaluating the advertising value created. By analyzing the data being generated, such as the number of individuals requesting information about a certain business or type of business, the demographics of the individuals requesting information, the responses of the individuals, and other significant information, a business client can tailor its marketing and advertising activities to specifically attract a specific type of customer. In a preferred embodiment, the personal contact and marketing system of the present invention also provides means whereby a business client can include in its information copy, website address links, graphical images, streaming video, audio, and other Internet-ready content to increase the effectiveness of its marketing and then track its effectiveness. In another preferred embodiment, a business client can use the system to develop and update calendars, events, mail lists, downloads, such as but not limited to photographs, statistical information, blog responses, and the like, and paste or link them to the business client's own web-page (a web-page outside of the network).

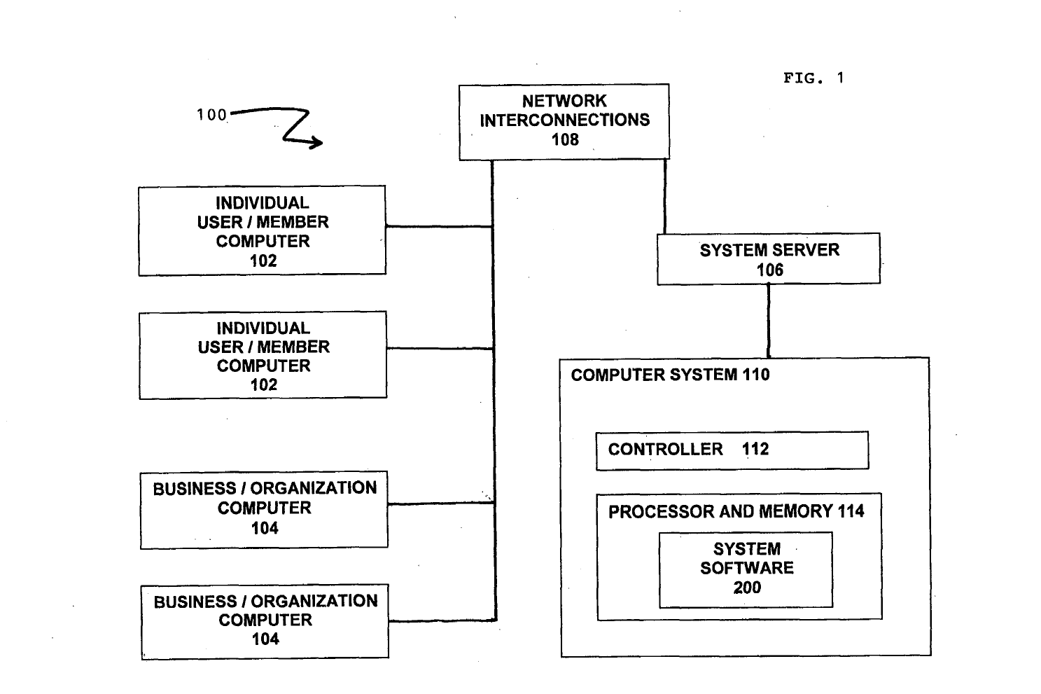

Referring to FIG. 1,the personal contact and marketing system 100 preferably includes one or more individual user computers 102, one or more business computers 104, at least one system server 106 which all have means to be linked together via network interconnections 108. The network interconnections 108 may comprise a local or wide area network, or more preferably the Internet. It should be understood that the system 100 is not limited to use with the Internet and that other types of network interconnections may be utilized such as using proprietary network interconnections such as through text messaging systems, telephones, PDA's, and the like.

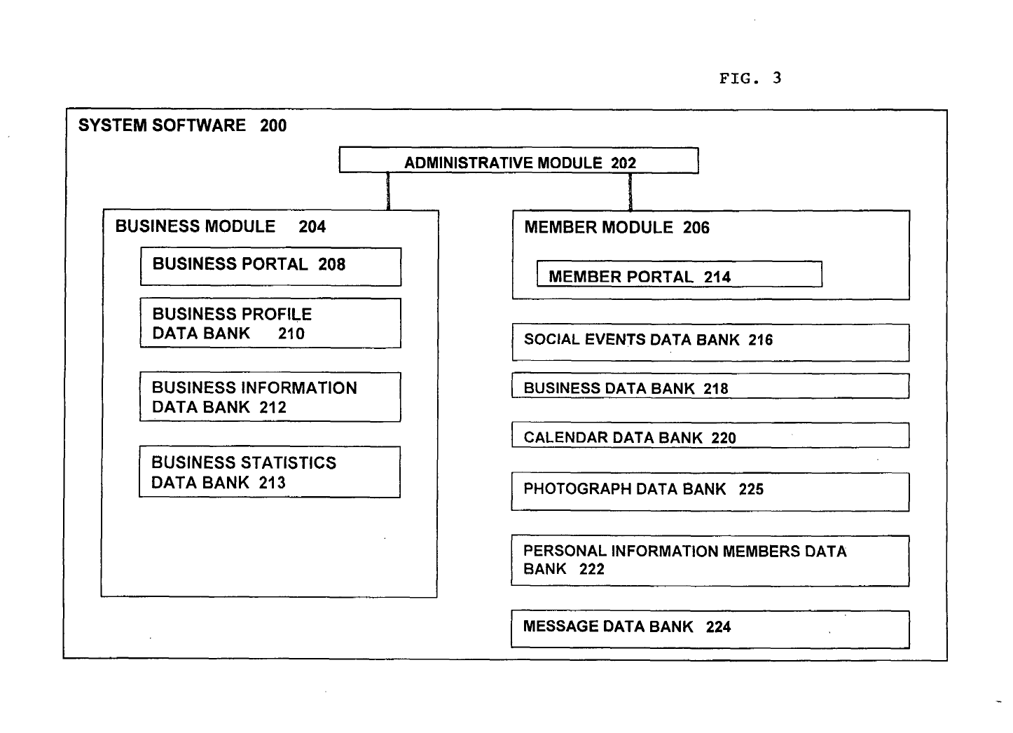

The personal contact and marketing system 100 further comprises an administrative computer system 110 for implementing the system software 200 (FIG. 3) that performs the method of the subject invention and is operated by a system administrator (not shown), and which is linked to each system server 106 used to assess and retrieve information with respect to a website, via various web-pages as described herein below, associated with the system 100. The computer system 110 includes a controller 112, a processor and a memory 114 that may be coupled to other devices, such as a suitable input device, like a keypad, touch screen, or any other suitable input device (not shown) that can accept information, and one or more suitable output devices (not shown), such as a computer display, printer, and the like. It should be understood that the computer system 110 can include any combination of the above components, or any number of different components, peripherals, and other devices. Preferably, the computer system 110 operates under the control of an operating system, such as the WINDOWS™ operating system developed by Microsoft Corporation or the Macintosh™ operating system developed by Apple Computer Corporation. It should be understood, however, that other operating systems could be utilized to implement the system software 200 (FIG. 3) of the personal contact and marketing system 100 of the present invention.

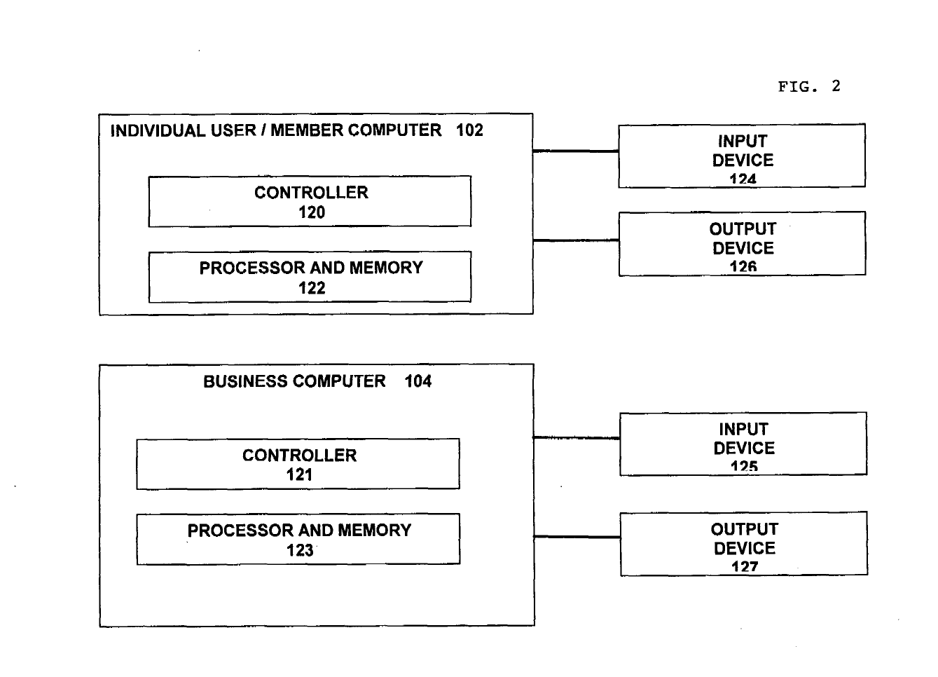

Referring to FIG.2, each individual user computer 102 and business computer 104 includes a controller 120 and 121, respectively, and a processor and a memory 122 and 123, respectively. Each individual user computer 102 and business computer 104 also has a suitable input device 124 and 125, respectively, like a keypad, touch screen, or any other suitable input device that can accept information and one or more suitable output devices 126 and 127, respectively, such as a computer display, printer, and the like. It should be understood that each individual user computer 102 and business computer 104 can include any combination of the above components, or any number of different components, peripherals, and other devices. The individual user computers 102 and business computers 104 are preferably configured such that they may communicate with each system server 106 (FIG. 1) such as through the Internet via the network interconnections. 108, such as a DSL modem or a cable modem, a T-1 line, ISDN line, or the like. The software for telecommunications is preferably browser software suitable for communications over the Internet and operates with the system software 200 for performing the method of the subject invention.

Referring to FIG. 3, a flow diagram is shown illustrating the general methodology of the system software 200 of the personal contact and marketing system 100 of the present invention. As shown the system software 200 comprises an administrative module 202, a business module 204, and a members module 206. The system software 200 is a computer-readable medium having computer-readable instructions for performing a method of operating the personal contact and marketing system, including generating the various web-pages, described hereinbelow, to be displayed on the output devices 126, 127 for use by member/users and business clients in inputting information into the system. Preferably, the system software 200 is also an interactive, menu and event driven system that cooperates with the system server 106 (FIG. 1) for using conventional type of prompt, dialog, and entry windows to guide a user to enter information thereby providing an interactive communications interface for facilitating communications and information exchange between individual users and between individual users and business clients. As used herein, the term “software” refers to any form of programmed machine-readable language or instructions (e.g., object code) that, when loaded or otherwise installed, provides operating instructions to a machine capable of reading those instructions, such as a computer. The system software 200 of the present invention can be stored or reside on, as well as be loaded or installed from, one or more floppy disks, CD ROM disks, hard disks or any other form of suitable non-volatile electronic storage media. The system software 200 can also be installed by downloading or other form of remote transmission, such as by using Local or Wide Area Network (LAN or WAN)-based, Internet-based, web-based or other remote downloading or transmission methods.

As shown, the administrative module 202 is shown and provides the interface between the members module 206 and the business module 204 as well as providing the ability to manage individual member and business accounts; provides the ability for user registration; the creation, storage and retrieval of specific user/business information; and other demographic information. The business module 204 preferably comprises a general business portal or access 208. The system software 200 operates to store and retrieve information from a business profile data bank 210, a business information data bank 212, and a business statistics data bank 213. The members module 206, as shown comprises a general member portal or access 214 and is in direct communication with a social events data bank 216, a business data bank 218, a calendar data bank 220, a photograph data bank 225, a personal information members data bank 222, and a message data bank 224.

Referring to the figures, and specifically to FIG. 4, the members module 206 and the administrative module 202 are shown whereby a user first accesses the members module 206 through the general members portal or access 214, such as through a web-page 302 (e.g. HTML page). The user can then register oneself with the system 100 to become an individual member of the network. To initiate the system, the individual user using an individual user computer 102 obtains access the system server 106 via network intercommunication 108 to visit the server website (step 400) within the system server 106. The system software 200 directs the server to display an opening web-page (step 401) (e.g. HTML page) 302 that provides the user with various options including reviewing local business events, information about specific venues, finding “friends,” sending and receiving messages, reviewing special offers, reviewing blog articles, reviewing and displaying photographs, and reviewing and entering contests. It should be understood that as used herein the terms “friend” or “friends” refer to those individuals that have been identified and listed as members within an individual member's neighborhood. The opening web-page 302 also provides means whereby the user can request to become a member of the network. Upon request by the user (step 402), such as by selecting the “sign-up” field 304, the system software 200 operates to automatically direct the system server 106 to display on the user's output device 126 a registration web-page 322 (step 403) (e.g. HTML page), as will be described below, which permits selection and data entry into various fields. As shown, users are also given the option of selecting from a variety of web-page fields that the user may be interested in viewing. Such web-page fields include an “events” field 306, a “venue” field 308, a “friends” field 310, a “message” field 312, an “offer” field 314, a “blogs” field 316, a “photo” field 318, and a “contests” field 320. It should be understood that by selecting any one of the listed fields (or other fields described below), the system software 200 will operate to automatically have the system server 106 display the appropriate web-page for viewing on the user's or business client's output device 126 and 127, respectively.

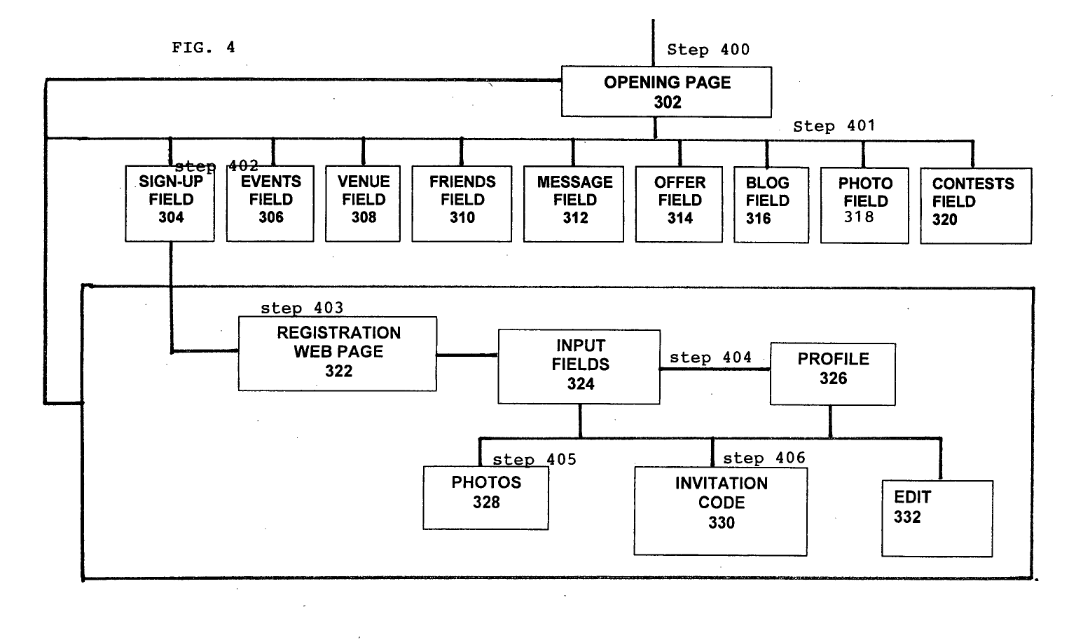

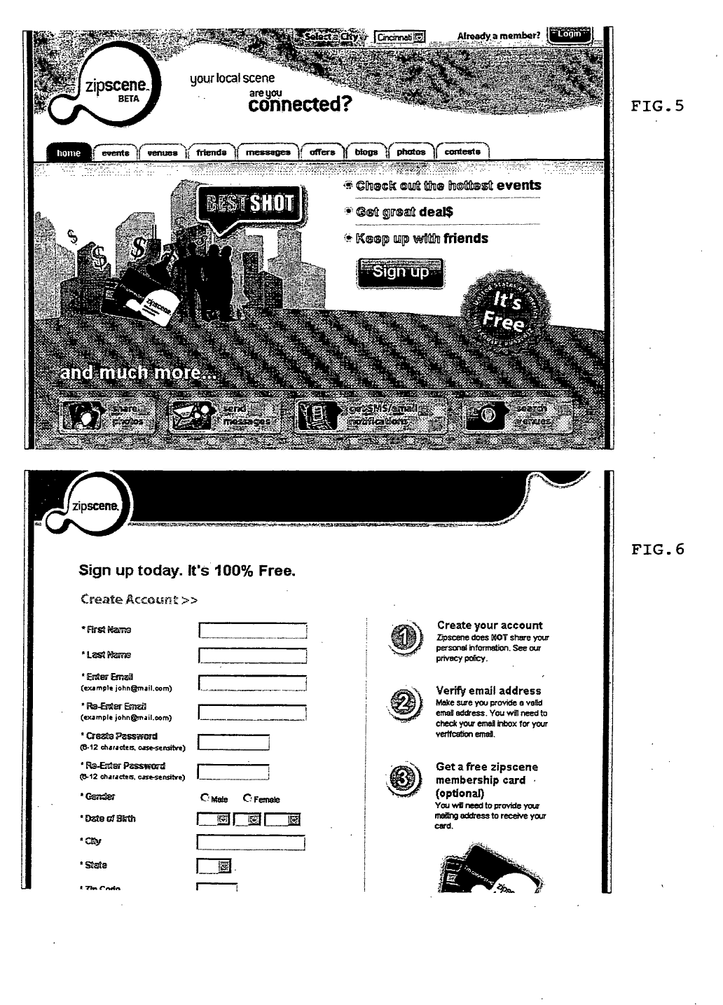

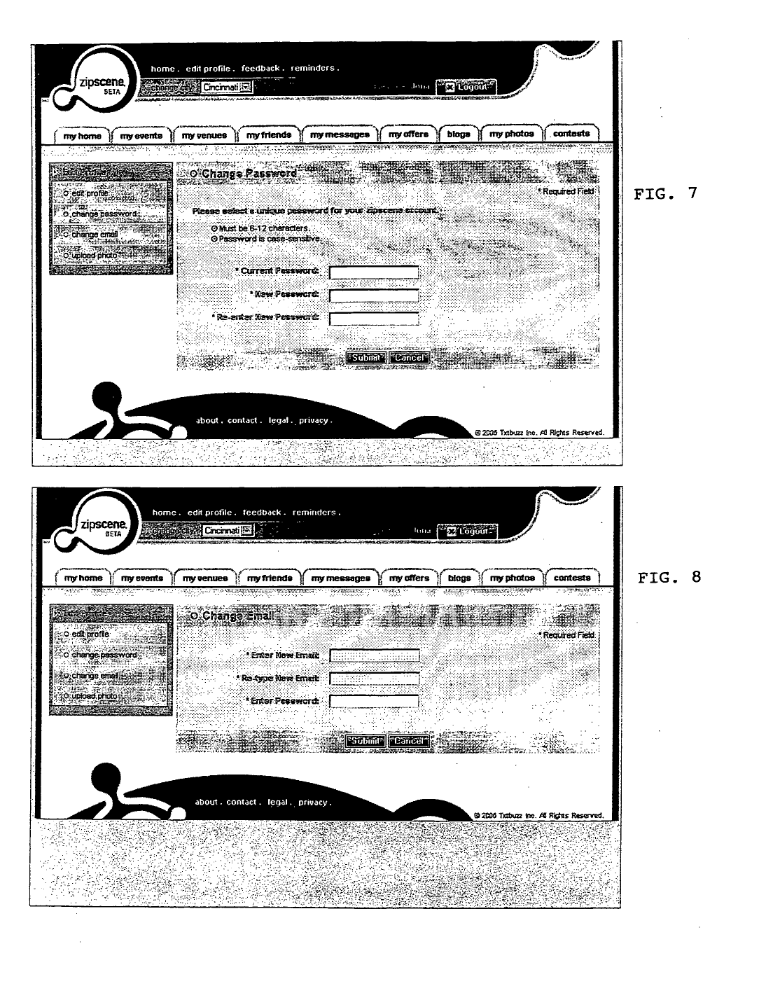

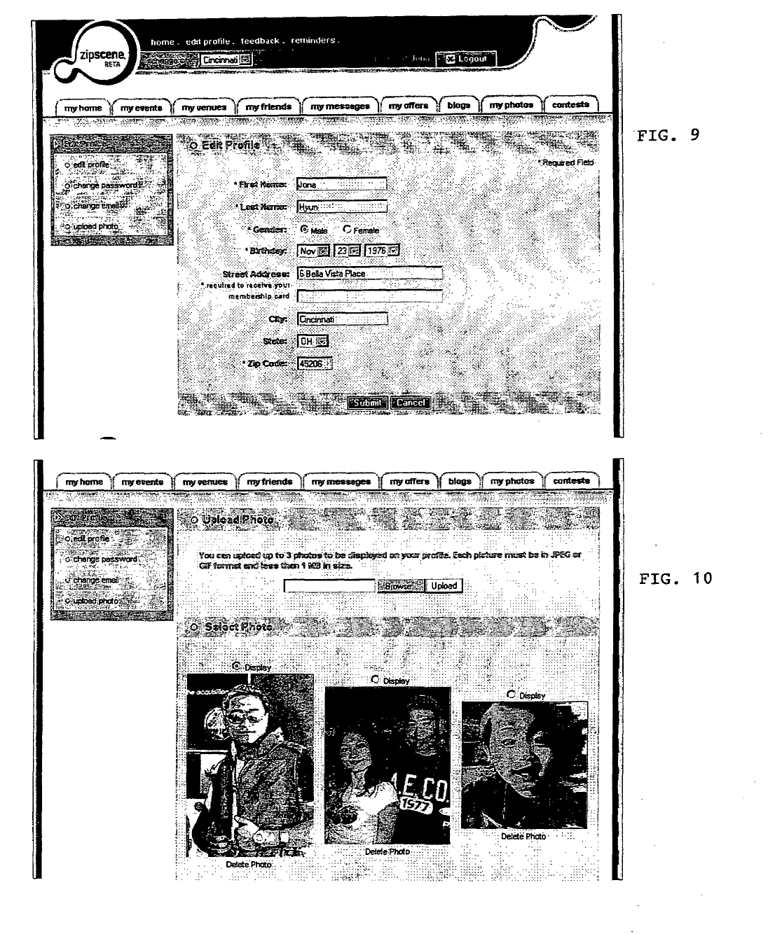

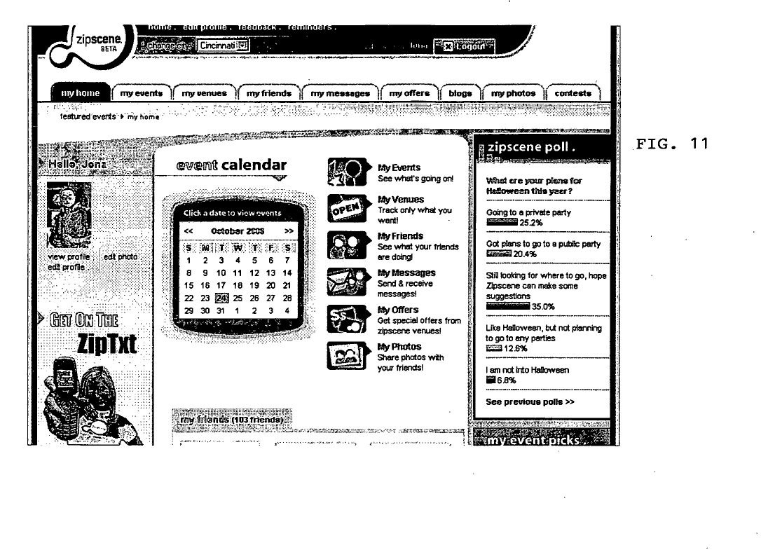

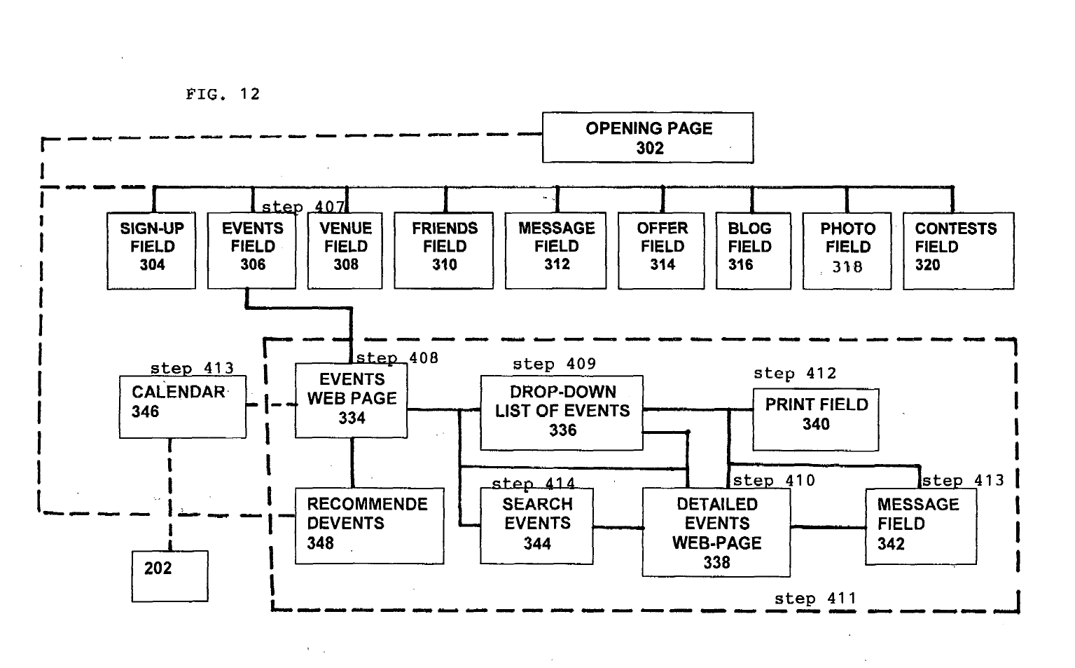

As illustrated in FIG. 4, referring to the user registration, from the opening web-page 302 the user is permitted to request registration, such as by selecting the “sign-up” field 304 that directs the system software 200 to display a registration web-page 322. Accordingly, once the user requests to register into the network, the system server 106 displays the registration web-page 322 (e.g. HTML page) on the user's output device 126 (FIG. 2) thereby allowing the user to register “on-line” via the Internet. The registration web-page 322 includes various input fields 324 that are provided for data entry or personal information for creating a basic member's profile 326 (step 404), which includes information about the individual user, such as for example the individual's name, date of birth, Email address, location, and identifies various interests and likes of the individual. Such information is stored in the personal information members data bank 222 (FIG. 3). In a preferred embodiment, the individual user may also enter or retrieve one or more photographs 328 (step 405), which are also stored in the personal information members data bank 222, and an invitation-code 330 (step 406) (which will be described more fully below). After the user has registered, the user becomes a “member” of the network. Preferably, at any time the user/member can return to the opening web-page 302 or any otherweb-page by selecting the desired web-page field. FIG. 5 and FIG. 6 are exemplary illustrations of a representative opening web-page and a registration web-page, respectively, that would be generated by the system software 200 and displayed on the user's output device 126 (FIG. 2). The system software 200 is also provided with a security feature that ensures only the proper registered member is able to access the members account for inputting, modifying, and deleting personal member information, such as a member's profile information. Preferably, the security feature is the use of a conventional password feature, typically used to enter restricted areas of an Internet website, however other Internet website security features, such as conventional user ID system or an Email access mechanism, could be used. It should be understood that the security feature will be utilized by the system anytime a user, member or business client attempts to gain access to various information stored within the system or to modify, edit, or add such information into the system. As shown, in FIG. 4, a member can modify, edit, or delete certain information, such as passwords, Email, photographs, and profile information by selecting the appropriate edit field 332. FIG. 7 is an exemplary illustration of a representative “change password” web-page that could be conventionally generated by the system software 200 showing how a user can change a member's password for access into the system by inputting a new password into the system. FIG. 8 is an exemplary illustration of a representative “change Email” web-page showing how a user can change a member's Email address for receiving information through the system. FIG. 9 is an exemplary illustration of a representative “edit profile” web-page showing how a user can change a member's profile stored within the system by inputting new profile information into the system. FIG. 10 is an exemplary illustration of a representative “upload photo” web-page showing how a user can upload one or more photographs to be displayed along with the member's profile information. FIG. 11 is an exemplary illustration of a representative member's “home” web-page showing the member's calendar and various fields that can be selected by the member.

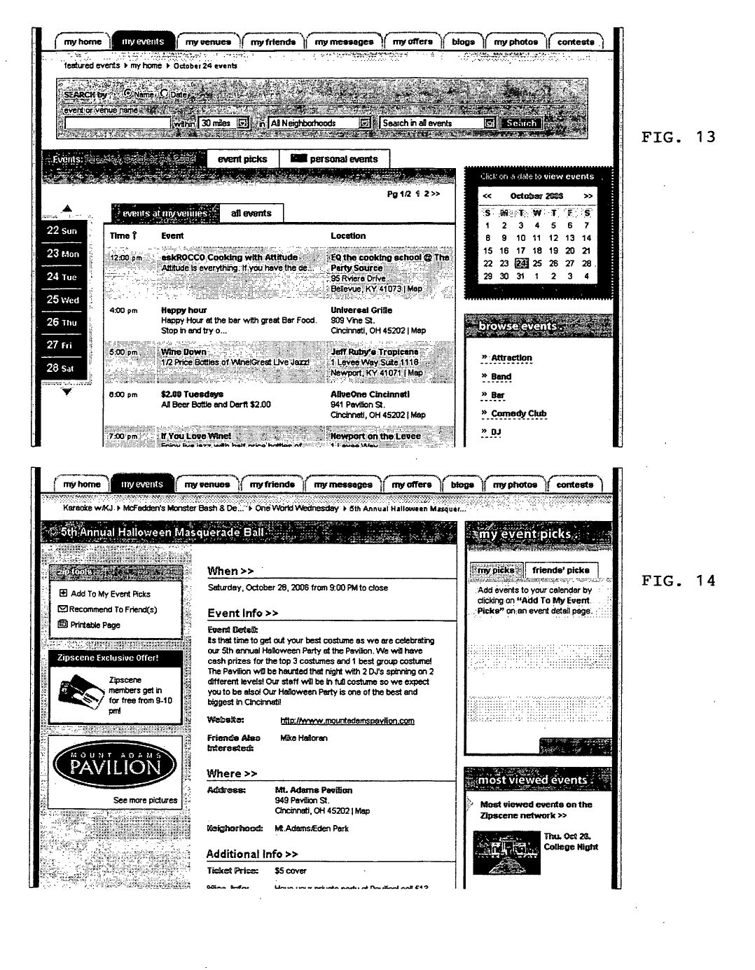

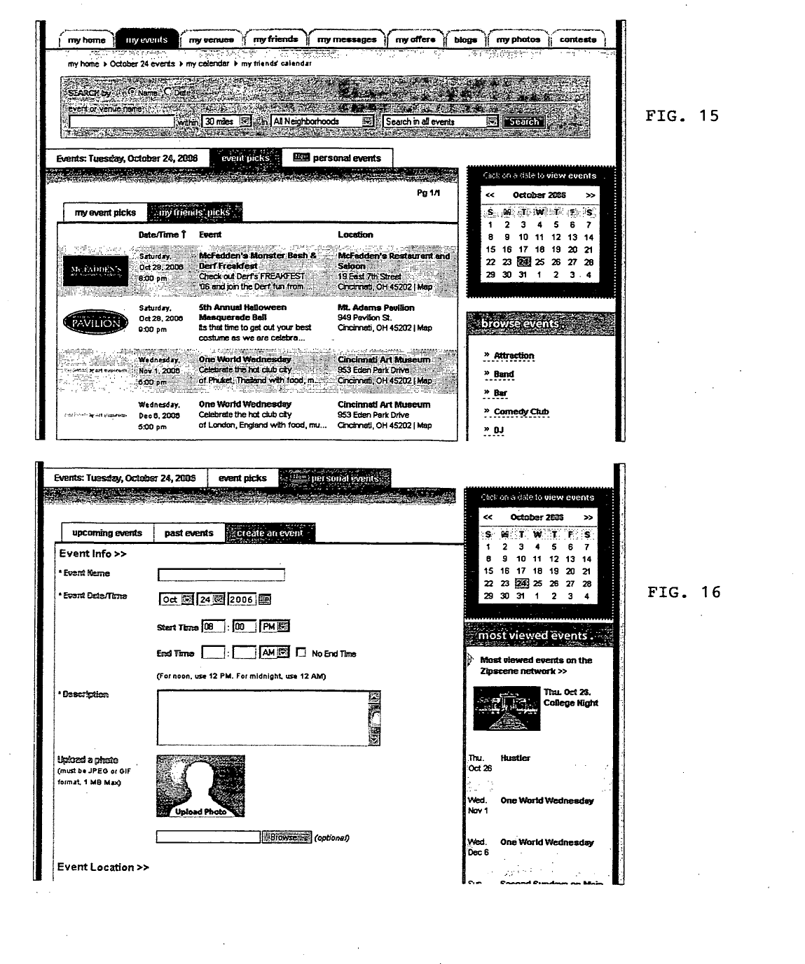

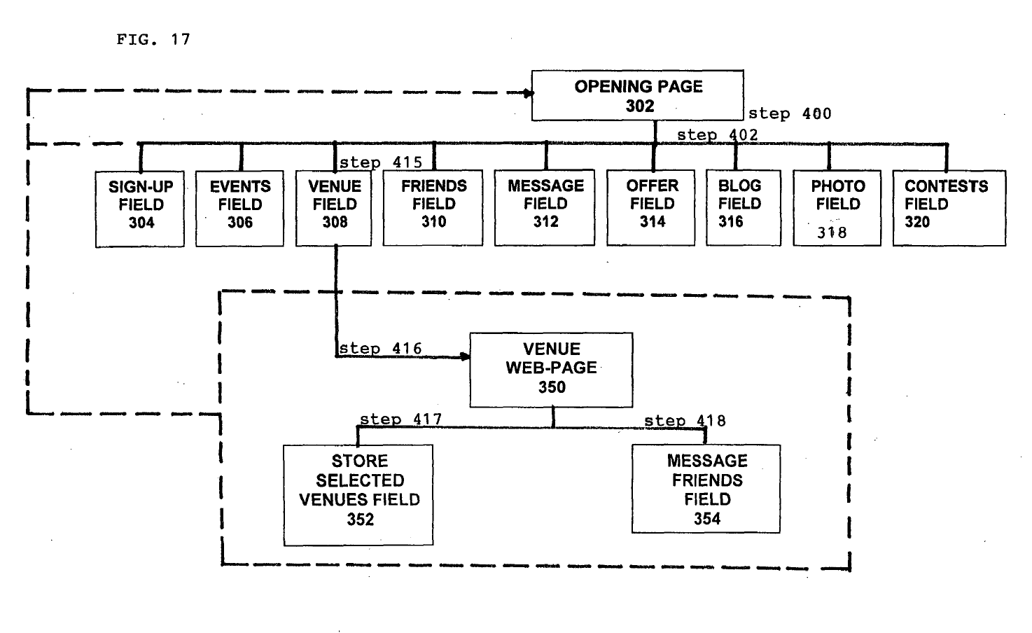

Referring again to the opening page 302, the user or member can select from one of the other listed fields. With regard to the “events” field 306, as shown in FIG. 12, when selected by the user (step 407) an “events” web-page 334 is displayed (e.g. HTML page) (step 408) on the user's output device 126 (FIG. 2) and a drop-down list 336 of various community events are displayed for viewing. Included in the list 336 is certain relevant information, such as for example the name of the event, location (venue) of the event, and date and time of the event. The user is also permitted to request and obtain more specific information concerning one or more particular events by selecting (“clicking” on) the particular event (step 409). If selected, the system software 200 then operates to display a detailed event web-page (step 410) 338 that provides more detail about the selected event (e.g. HTML page) on the user's output device 126. It should be noted that the user may select the “print” field 340 (step 411) to print the information using the appropriate user's output device 126 or may select the “message” field 342 (step 412) to send a message to a “friend” suggesting that he/she review the information concerning a specific event. Further, the system software 200 provides each user who is an individual member a personal interactive calendar 346 whereby the user can request that the event or other activity be placed on the user's personal calendar 346 which is then stored in the calendar data bank 220 (step 413). It should also be understood that in a preferred embodiment, events and offers by venues that have been previously identified by the individual member as being of interest, will be automatically added to the individual member's calendar by the administrative module 202 of the system software 200. In this way individual members can review all of the events and offers being made by venues of interest and which have been stored in the system by simply reviewing their individual calendar. In a preferred embodiment, an individual member may also create a “private” event, such as for example a birthday party or private party, and can invite “friends” or other members to attend (FIG. 16). Such invitations can be in the form of a message, such as by Email, instant messaging, and the like, or the individual member using the system software 200 can request that the event be placed onto one or more “friends” calendars. It should be understood that the individual member can direct the system software 200 to maintain the event as “private” (event information is to be viewable only by “friends” listed in the individual member's friends listing or viewable to only specific “friends”) or direct the system software 200 to register the event as “public” (viewable to the entire community). In a preferred embodiment of the invention, the user may select the “search” field 344 (step 414) directing the system software 200 to operate and permit the list of events stored within the business events data bank 212 to be searched, either by event name or event date, and/or within a certain distance from a location (FIG. 13). In another preferred embodiment, the user can also direct the system software 200 to search based on the particular type of event, such as for example “sports” events that are scheduled during a period of time, venues, locations, or other such parameters. In addition, individual members can also search recommended events by selecting the “recommended events” field 348. Preferably, the “recommended events” field 348 comprises those events that have received the greatest interest by users/members. For example, recommended events may comprise those events receiving the greatest number of requests (“clicks”) for information by users, or the greatest number of messages concerning the event, or the greatest number of calendar listings, any other statistical information deemed appropriate by the system administrator. It should be understood, that the recommended events may also be listed based on the particular member's identified events. For an illustrative example, if the member has identified sporting events to be of interest, the recommended events listed for that particular member may be directed to the most popular sporting events. Accordingly, each individual member is provided a recommendation listing that is along the lines of that member's particular interest. At any time the user/member can return to the opening web-page or any other web-page by selecting the desired web-page field. FIG. 13 is an exemplary illustration of a representative “events” web-page 334 showing a drop-down events list and FIG. 14 is an exemplary illustration showing more detailed information about each listed event. FIG. 15 is an exemplary illustration showing a drop-down list of events selected by a member's “friend” for review by the member. FIG. 16 is an exemplary illustration showing how a member can create his/her own personal event.

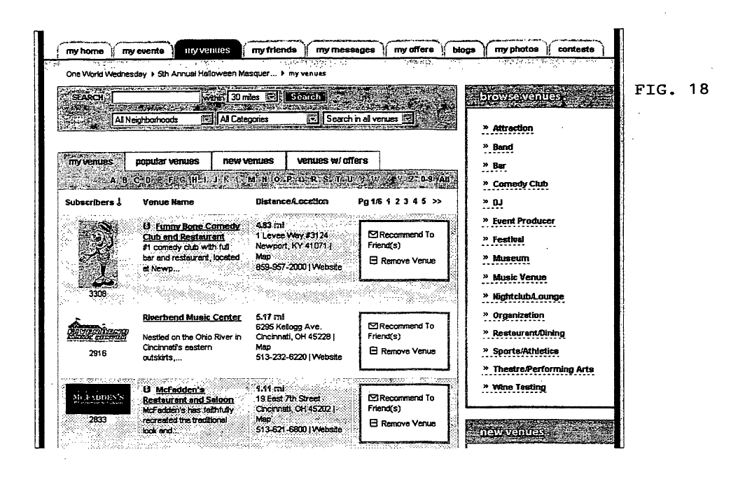

Referring again to the opening web-page 302, the user/ member can select from one of the other listed fields. With regard to the “venue” field 308, as shown in FIG. 17, when selected by the user/member (step 415), the venue web-page (e.g. HTML page) 350 is displayed (step 416) on the user/member's output device 126 (FIG. 2). Preferably, the venues listed on the venue web-page 350 comprise various entertainment businesses, however, it should be understood that other types of businesses may also be included in the system. The user/member can review the entire list of venues or can select the venues according to location, or alphanumerical, specific type of venue, or other such criteria which is then displayed on the user/member's output device 126. Individual members/users may also review a list of recommended venues. Preferably, the recommended venues comprise those venues that have received the greatest interest by users. For example, recommended venues may comprise those venues receiving the greatest number of requests by user/members for information, or the greatest number of messages, or the greatest number of calendar listings, or any other statistical information deemed appropriate by the system administrator. It should be understood, that the recommended venues may also be listed based on the particular member's identified venues. For an illustrative example, if the member has identified venues (as described herein) that typically comprise night clubs to be of interest, the recommended venues listed for that particular individual member can include the most popular night club entertainment venues. Accordingly, each individual member will be provided a recommendation venue listing that is along the lines of the member's particular interest.

The member can select (step 417) a store selected “venue” field 352 that instructs the system software 200 to operate and allow an individual member to identify those venues of interest and record such venues in the members business data bank 218 (FIG. 3). The individual member can also select (step 418) a “message” field 354 that instructs the system software 200 to operate and allow individual members to send messages to “friends” or other individual members information concerning the selected venue. At any time the user/member can return to the opening web-page 302 or any other web-page by selecting the desired web-page field. FIG. 18 is an exemplary illustration showing the venue web-page generated by the system software for displaying on the user/member's output device showing a listing of venues.

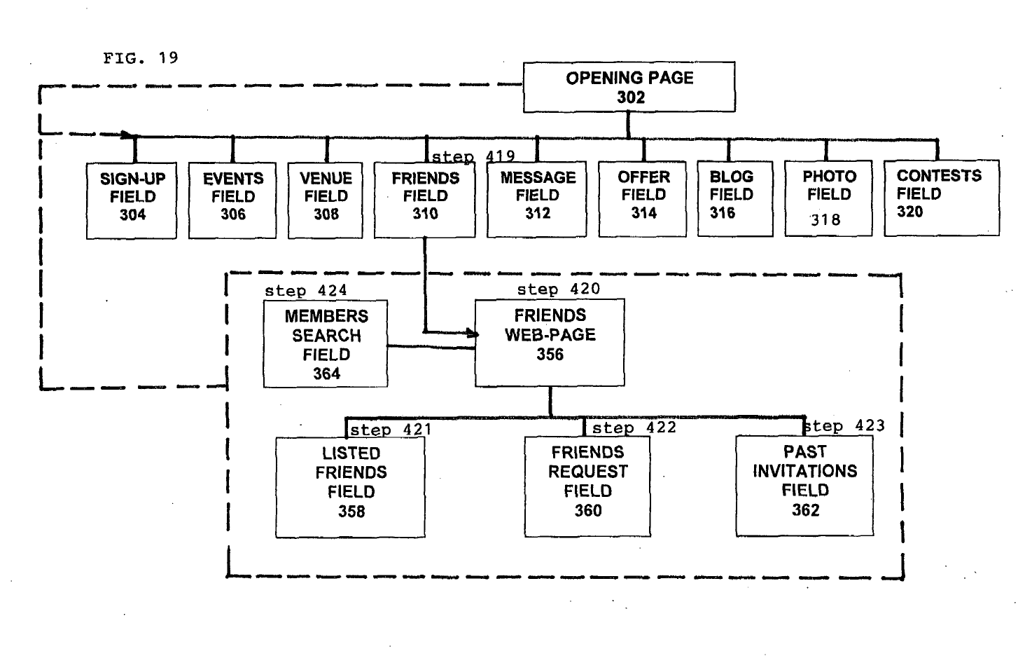

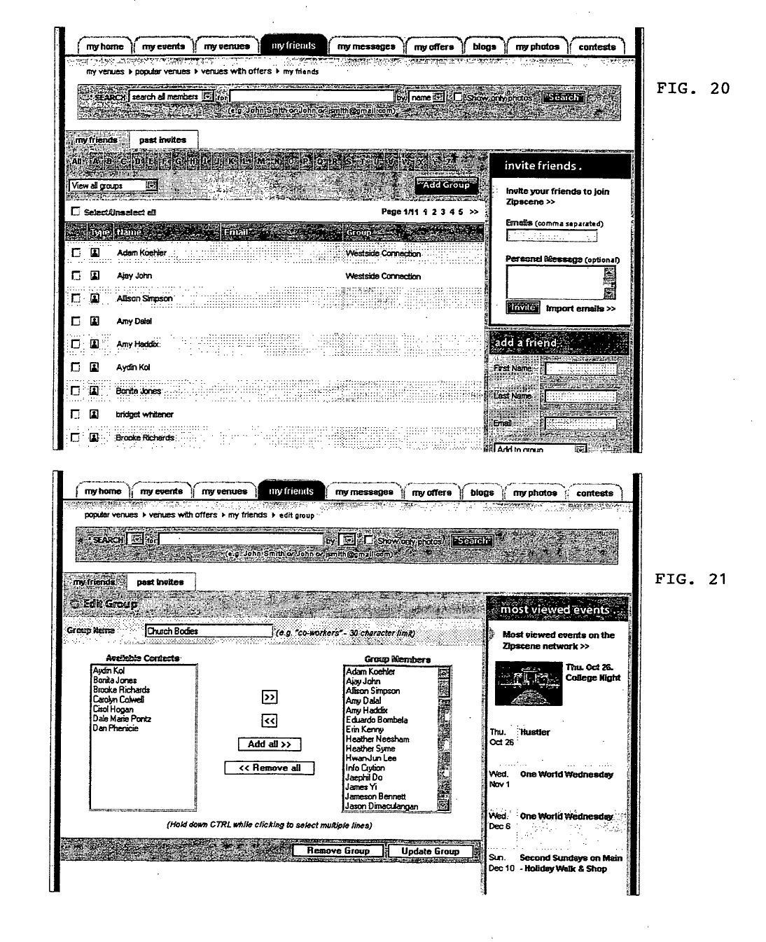

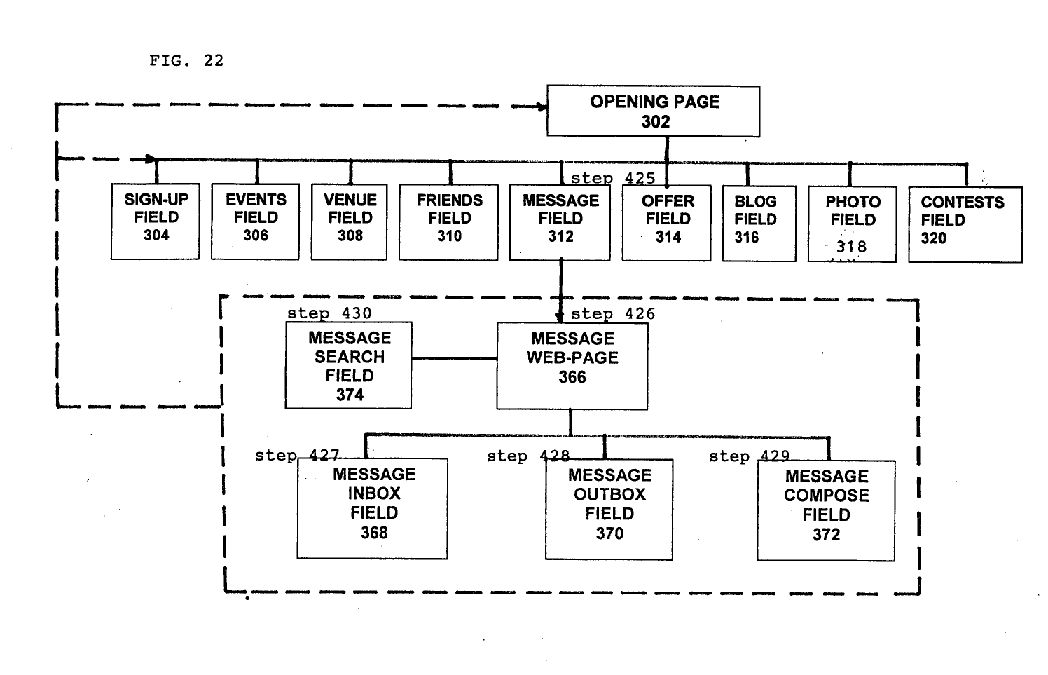

Referring to FIG. 19, users that have completed registration into the system 100 and have become members are permitted access to the “friends” web-page 356 (e.g. HTML page) by selecting the “friends” field 310 (step 419) on the opening web-page 302. When selected, such as by selecting the “friends” field 310, the system software 200 directs the system server 106 to display the friends web-page 356 (step 420) (e.g. HTML page). Preferably a “friend” is an individual, that is an acquaintance, friend, relative, other known user, or the like that the identifying user wishes to have in the member's neighborhood in order to share information with through the system. Individual members can then review or select “listed friends” (step 421) that they have identified and which are stored in the individual members personal members data base 222 (FIG. 3) by selecting the “listed friends” field 358, or the individual member may select (step 422) the “friends request” field 360 which when selected will direct the system software 200 to identify request that have been submitted by “friends” of the individual member, such as a request to review a social event, or the individual member can select (step 423) the “past invitation” field 362 which when selected will direct the system software 200 to identify past invitations sent to the individual member and which were stored in the social events data base 216 (FIG. 3). Individual members can also search for other individual members (step 424) by entering with their name or an Email address in the “members search” field 364. The system software 200 then identifies other members, using the search criteria inputted by the member, listed in the members data base 222. At any time the member can return to the opening web-page 302 or any other web-page by selecting the desired web-page field. FIG. 20 is an exemplary illustration of a friends web-page 356 showing a dropdown list of friends including their Email addresses and identifying any sub-group that the “friend” may be grouped, such as for example “tennis friends,” “business friends,” etc. As shown in FIG. 20, in the preferred embodiment, the member can also enter information into the system that operates to send an Email message to an individual inviting the individual to become a member of the system. FIG. 21 is an exemplary illustration showing how a member can edit his/her listing of friends or group friends into various subgroups.

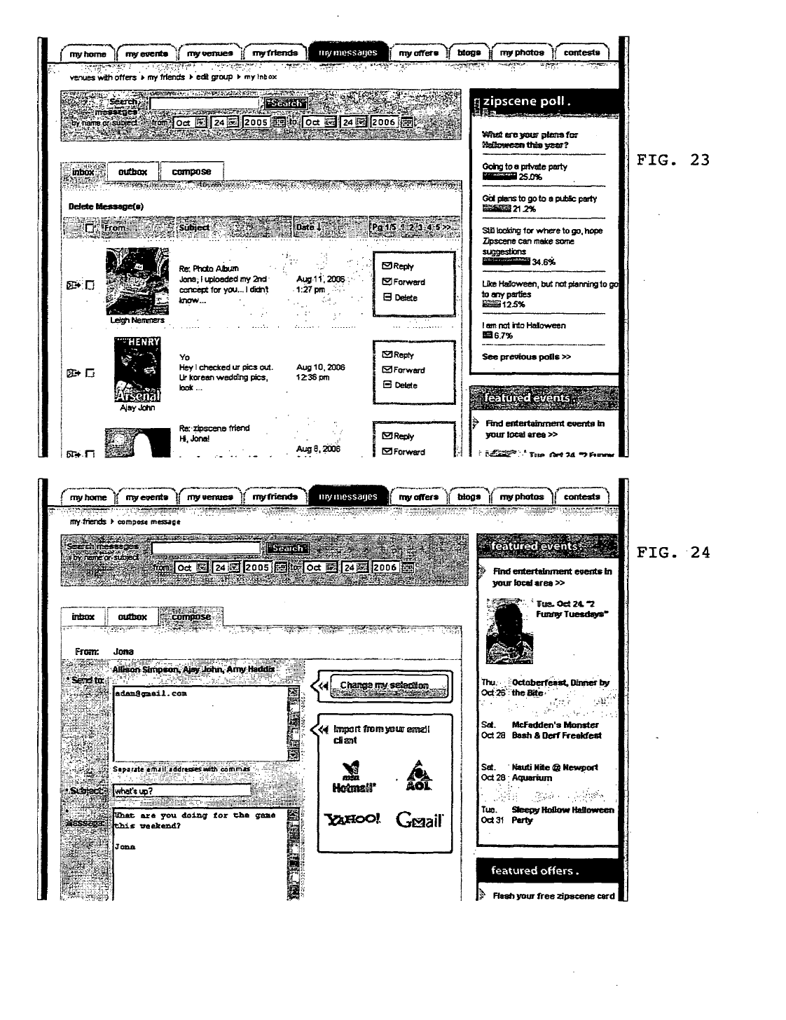

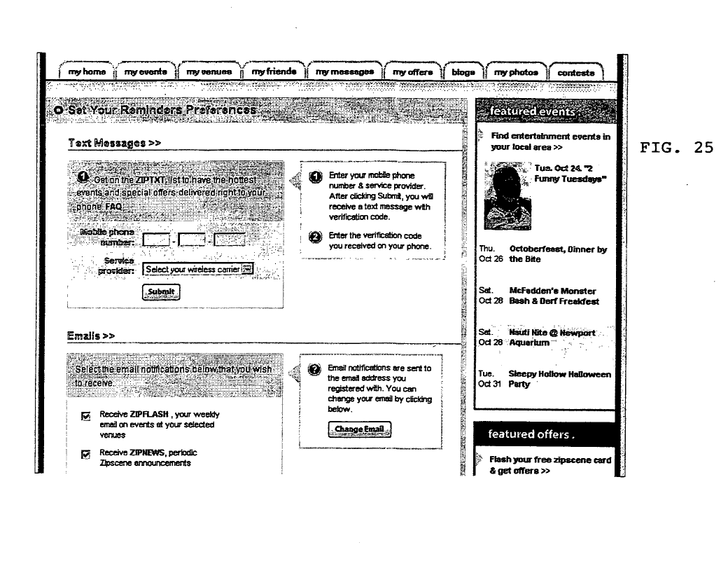

Referring to the opening web-page 302, users that have completed registration into the system 100 and have become members are also permitted access to the message web-page 366 (e.g. HTML page) by selecting (step 425) the “message” field 312 on the opening web-page 302. Referring to FIG. 22, when the member selects (step 425) the “message” field 312, the system software 200 directs the system server 106 to display the message web-page 366 (step 426). The individual member can then review his/her inbox (step 427) for messages sent by other members, review messages sent to other members (step 428), or compose messages to send to other members (step 429) by selecting “inbox” field 368, the “outbox” field 370, or the “compose” field 372, respectively. The member can also search for messages (step 430) by selecting the “message search” field 374 which then directs the system software 200 to search for messages in message data bank 224 (FIG. 3). At any time the member can return to the opening web-page 302 or any other web-page by selecting the desired web-page field. FIG. 23 is an exemplary illustration showing a message web-page 366 generated by the system software showing the various fields whereby the system software is directed to delete, reply or forward a message. FIG. 24 is an exemplary illustration showing a “compose” message web-page generated by the system software showing how a member can compose and send a message. FIG. 25 is an exemplary illustration showing a “text messages” web-page generated by the system software showing how a member can input a mobile phone number into the system to allow a member to receive text messages being transmitted by the system to be received by the member's telephone.

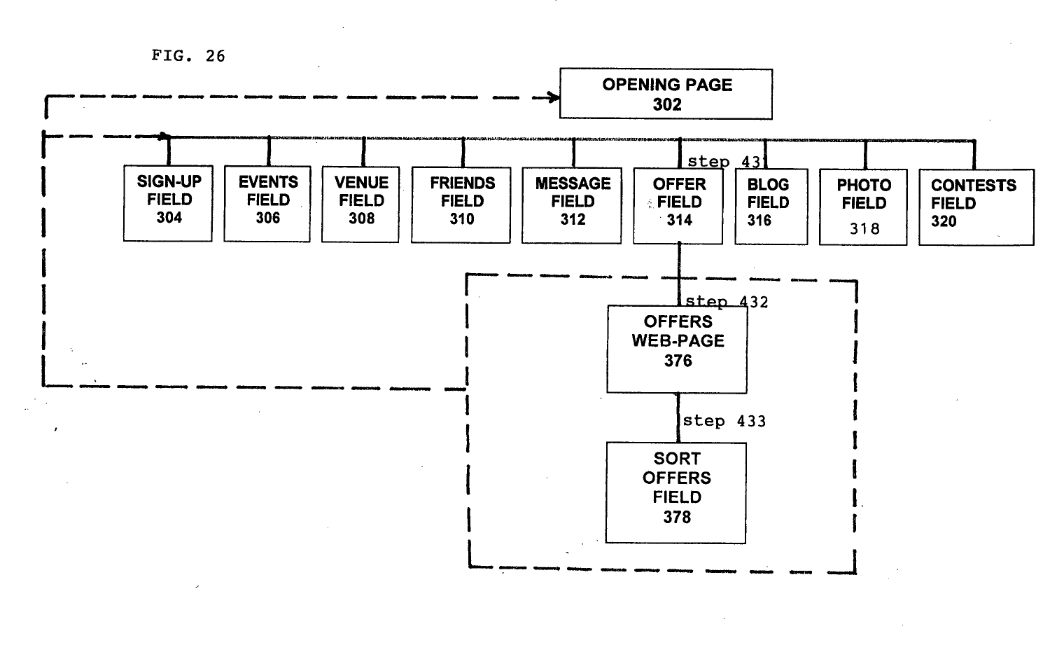

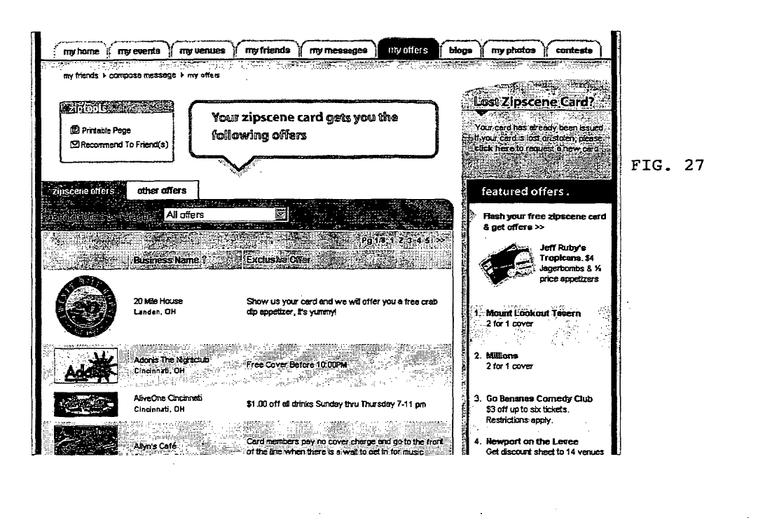

Referring again to the opening page 302, the user/ member can select from one of the other listed fields. With regard to the “offers” field 314, as shown in FIG. 26, when selected by the user/member (step 431), the system software 200 is directed to generate the offers web-page (e.g. HTML page) 376 which is displayed (step 432) on the user/member's output device 126 (FIG. 2). Preferably, the offers listed on the offers web-page 376 comprise various offers or promotions made by business clients. Such offers, for example, may include special discounts, promotion specials, and other such benefits. The user/member can scan down the entire drop-down list to review or by selecting the “sort offers” field 378 (step 433) the user/member can review the offers according to various criteria such as location, or alphanumerical listing, type of offers (i.e. offers being provided by night clubs or restaurants, etc.), or other similar criteria. The resulting list is then displayed on the user/member's output device 126. Users/members may also review a list of recommended offers. Preferably, the recommended offers comprise those offers that have received the greatest interest by users/members. For example, recommended offers may comprise those offers receiving the greatest number of requests (“clicks”) by users/members for information, the greatest number of messages, or calendar listings relating to such offers, or any other statistical information deemed appropriate by the system administrator. It should be understood that the recommended offers may also be listed based on the particular member's identified offers of interest. For an illustrative example, if the member has identified offers typically given by night clubs to be of interest, the recommended offers can be directed to the most popular offers provided by night club entertainment venues. Accordingly, each individual member will be provided a recommendation listing that is along the lines of the member's particular interest. At any time the user/member can return to the opening web-page 302 or any other web-page by selecting the desired web-page field. FIG. 27 is an exemplary illustration showing an offers web-page generated by the system software showing a listing of offers or promotions from business clients.

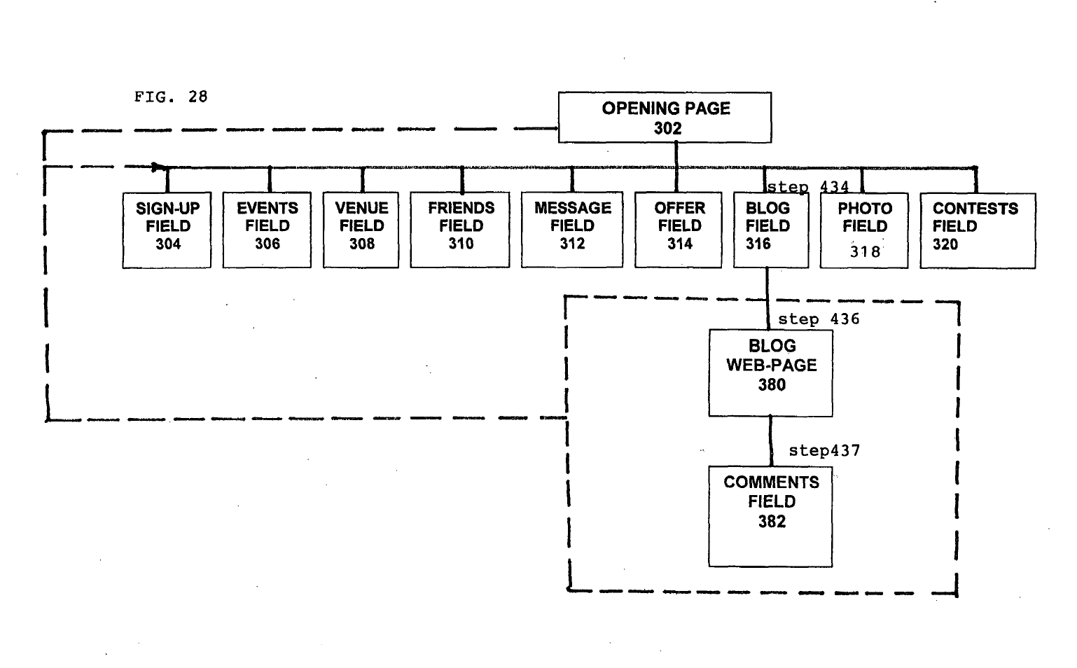

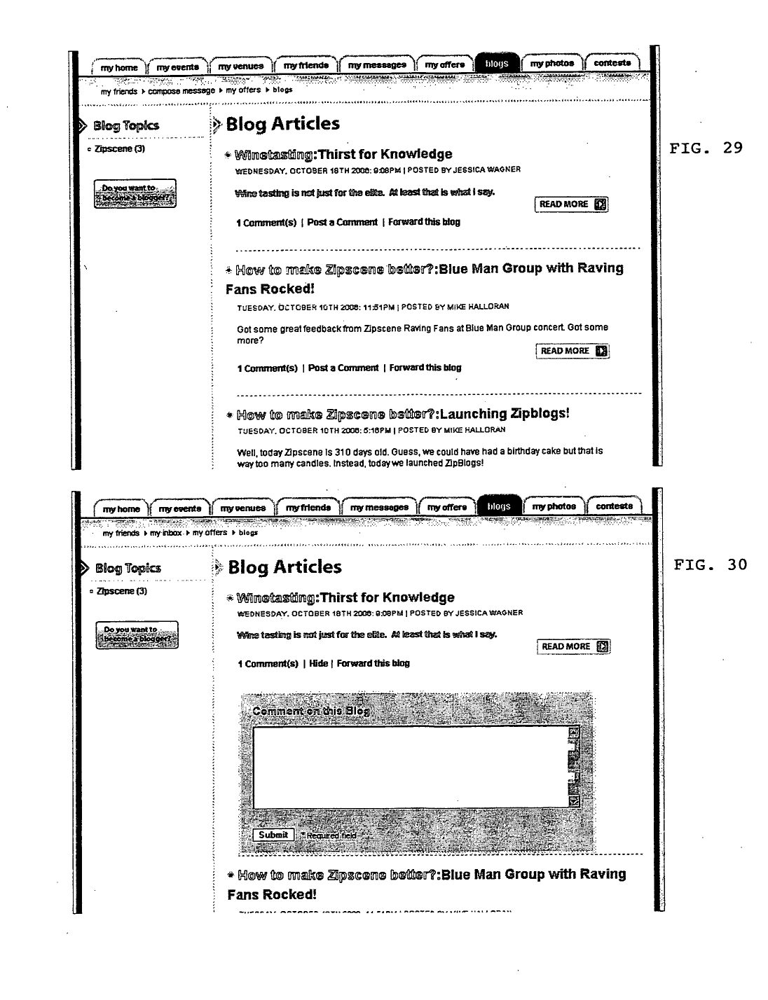

Referring again to the opening page 302, the user/member can select from one of the other listed fields. With regard to the “blogs” field 316, as shown in FIG. 28, when selected by the user/member (step 434), the system software 200 operates to display the blog web-page (e.g. HTML page) 380 (step 436) on the user/member's output device 126 (FIG. 2). Preferably, the articles listed on the blog web-page 380 comprise various articles posted by members and business clients. The blog web-page (an illustrative example is shown in FIG. 29) provides fields 382 for commenting, posting a comment and forwarding the blog when selected by the user/member (step 437) to another user or member. In an illustrative example, when the comment filed 382 is selected by the member, a comment web-page, such as illustrated in FIG. 30, is generated by the system software and displayed on the members output device 126. The member can then supply a comment and the system software will operate to post it for review by other members. At any time the user/member can return to the opening web-page 302 or any other web-page by selecting the desired web-page field.

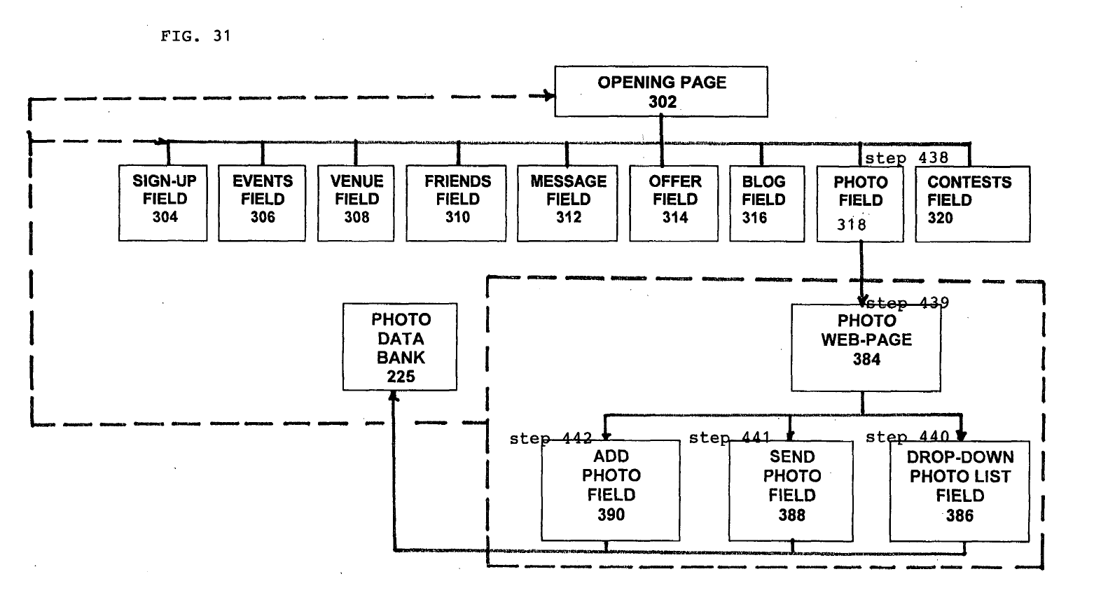

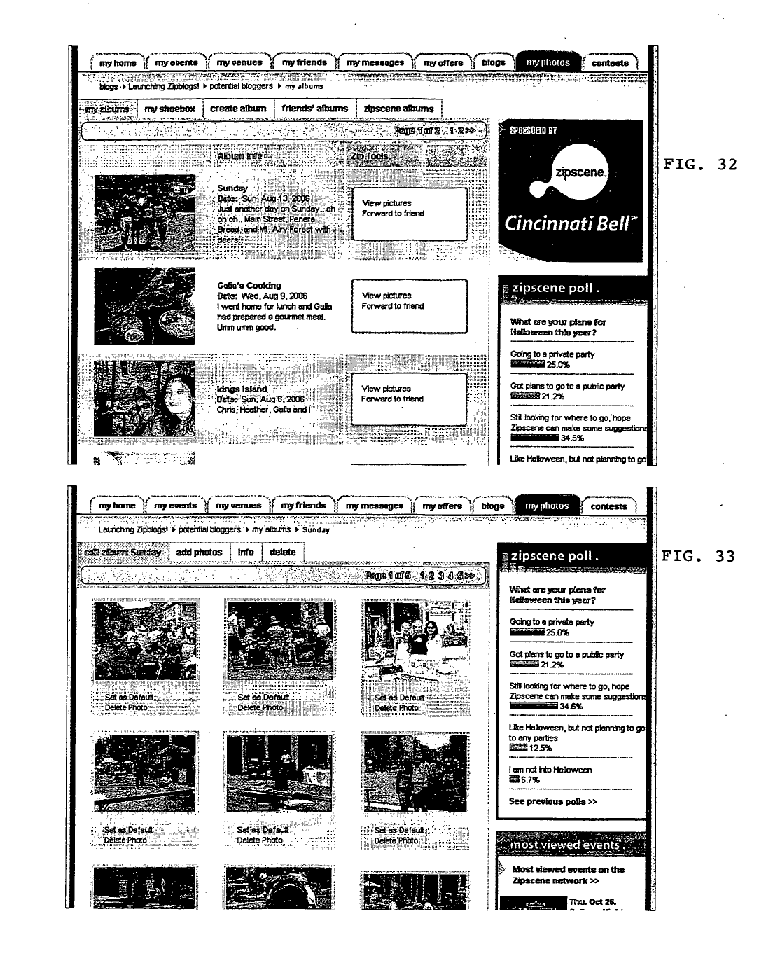

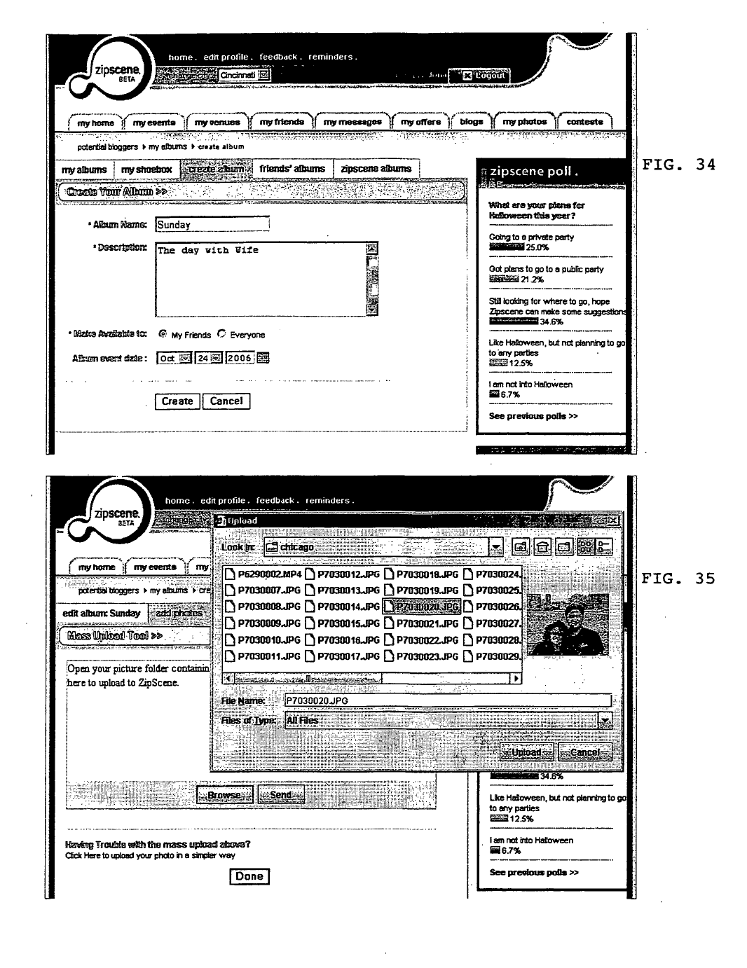

Referring again to the opening web-page 302, the user/member can select from one of the other listed fields. With regard to the “photo” field 318, as shown in FIG. 31, when selected by the user/ member (step 438), the system software 200 operates such that the photo web-page (e.g. HTML page) 384 is displayed (step 439) on the user/member's output device 126 (FIG. 2) and provides a drop-down list 386 (step 440) of various photos or sets of photos, that have been previously stored in the photo data bank 225 (FIG. 3), that the user/member can select and view. The user/member can select a photo or a set of photos which when selected are displayed in an enlarged format on the user/member's output device 126. The user/member can also select the “send photo” field 388 (step 441) to send a copy of a photo or select the “add photo” field 390 (step 442) to submit photos which then directs the system software 200 to send a photo to the selected member or to add a photo to the photograph data bank 225 (FIG. 3), respectively. It should be understood that members can display photos such that they are viewable only by the individual member's “friends,” by selected “friends,” or by the community. In a preferred embodiment, photos when displayed can be copied by the viewer and stored in the viewers computer or other medium, or they can be sent to other locations in or outside the network, such as by Email or by Internet messaging. At any time the user/member can return to the opening web-page 302 or any other web-page by selecting the desired web-page field. FIG. 32 is an exemplary illustration showing a photo web-page generated by the system software showing album information and the various fields which the member can select. FIG. 33 is an exemplary illustration of an “edit album” web-page generated by the system software allowing a member to edit the member's photograph albums. FIG. 34 is an exemplary illustration of a “create album” web-page generated by the system software showing how a member can enter an album into the system. FIG. 35 is an exemplary illustration of an “upload” web-page generated by the system software showing how a member can upload photographs into the system.

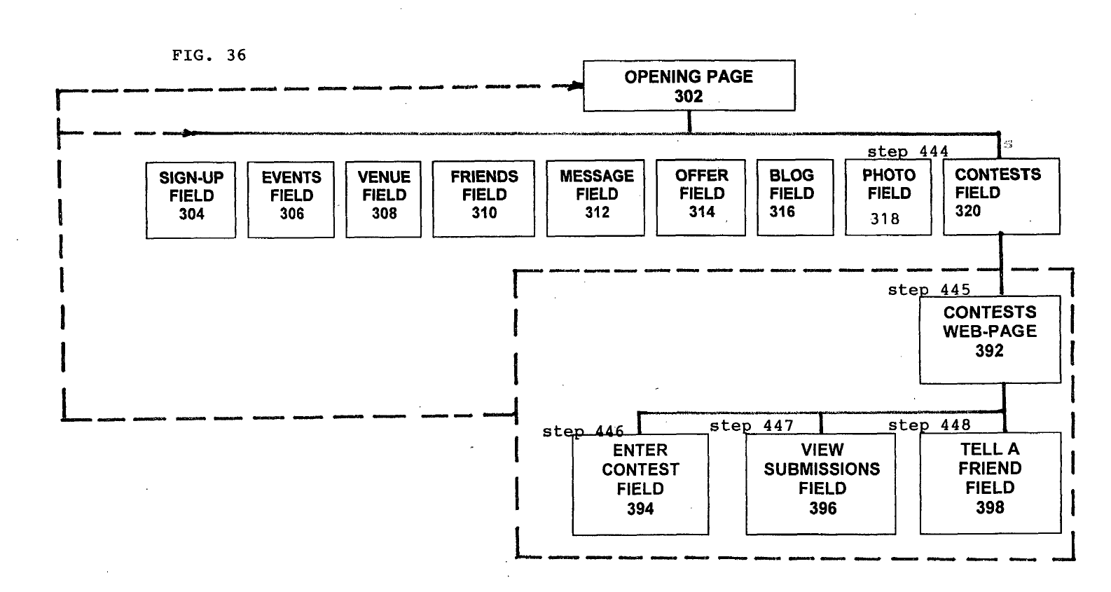

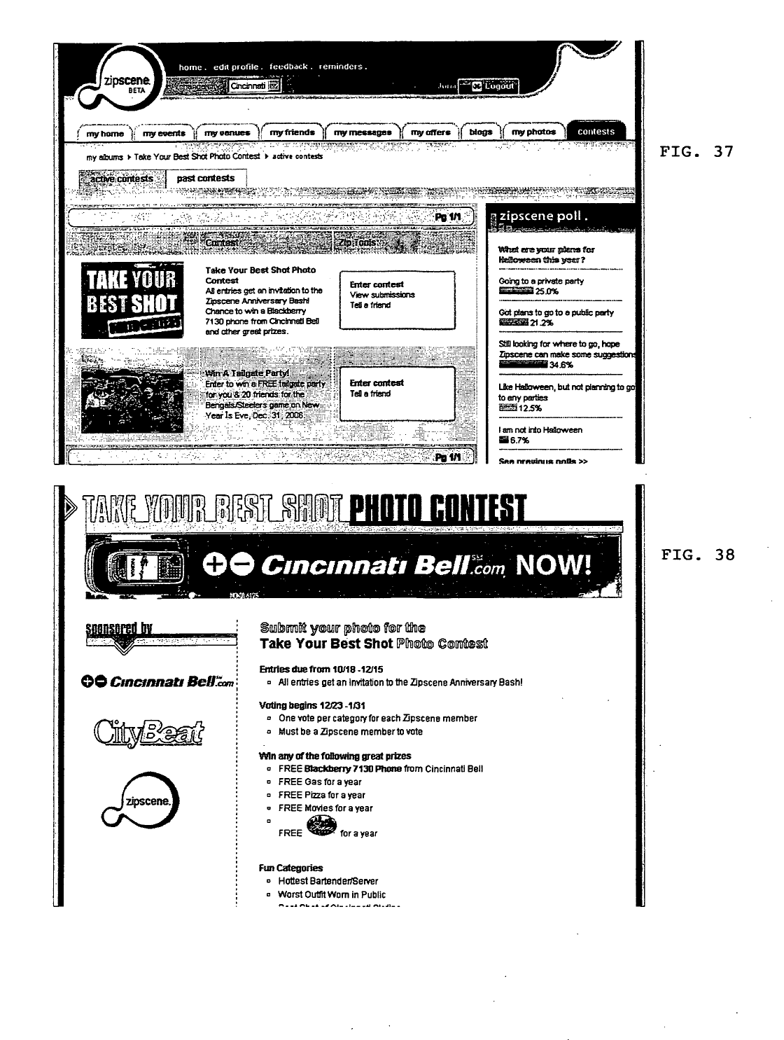

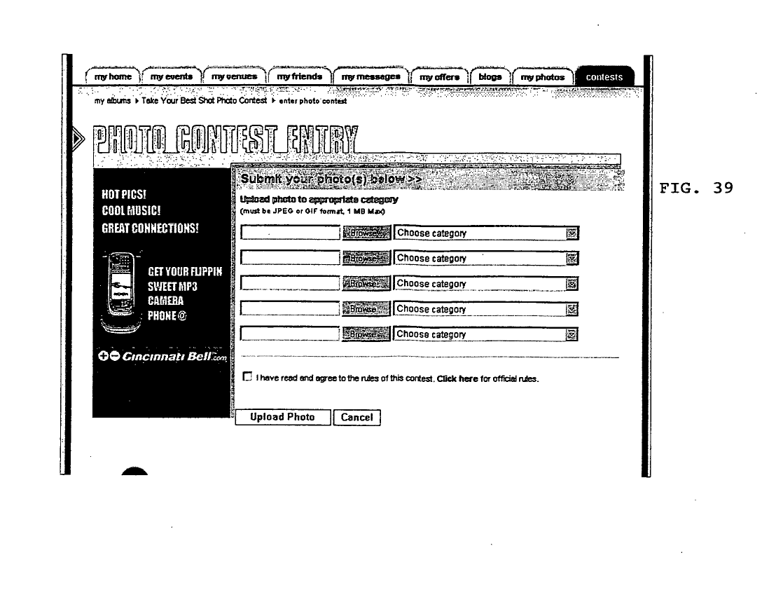

Referring again to the opening page 302, the user/ member can select from one of the other listed fields. With regard to the “contests” field 320, as shown in FIG. 36, when selected by the user/member (step 444), the system software 200 operates to generate a contests web-page (e.g. HTML page) 392 is displayed (step 445) on the user/member's output device 126 (FIG. 2). Preferably, the contests listed on the contest web-page 392 comprise various contests posted by the system administrator or by business clients. For each contest listed on the contests web-page 392, is a field allowing the member to enter the contest field 394 (step 446), view the submissions field 396 (step 447), or communicate the contest with a “friend” by selecting the tell a friend field 398 (step 448). In an illustrative example, when the “contests field 320 is selected, the system software generates the active contest web-page, such as illustrated in FIG. 37, on the members output device 126. The member can then enter the necessary information to enter the contest, such as shown in exemplary illustration shown in FIG. 39. In another illustrative example, when the “enter contests” field is selected by the member, such as illustrated in FIG. 38, the system software generates a web-page displaying detailed contest information on the member's output device 126. At any time the user/member can return to the opening web-page 302 or any other web-page by selecting the desired web-page field.

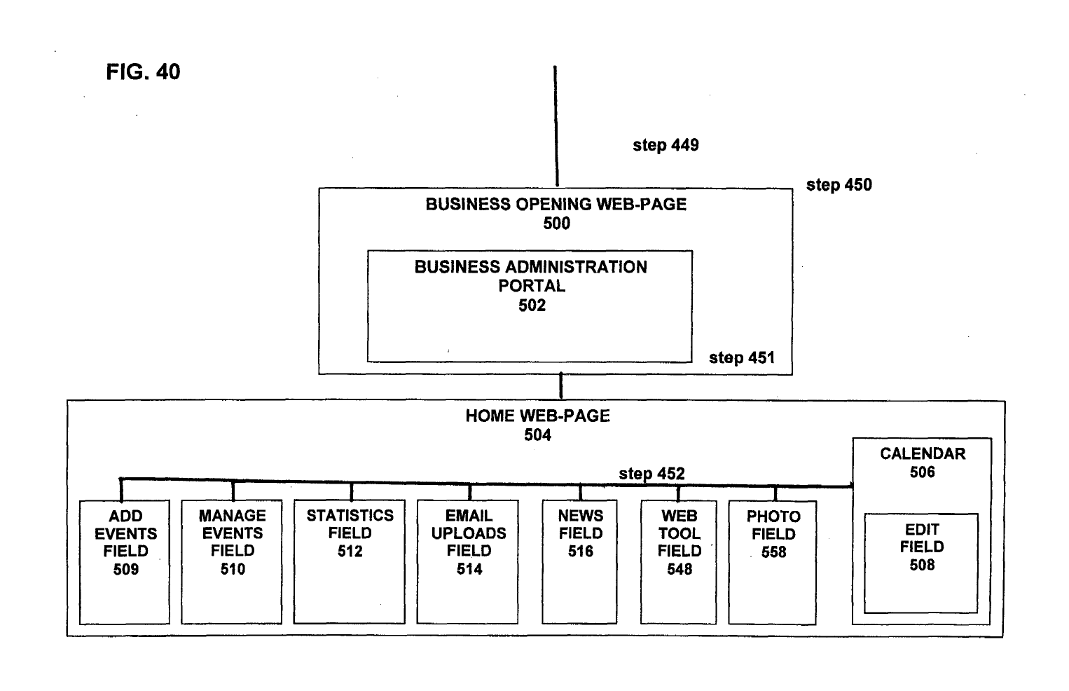

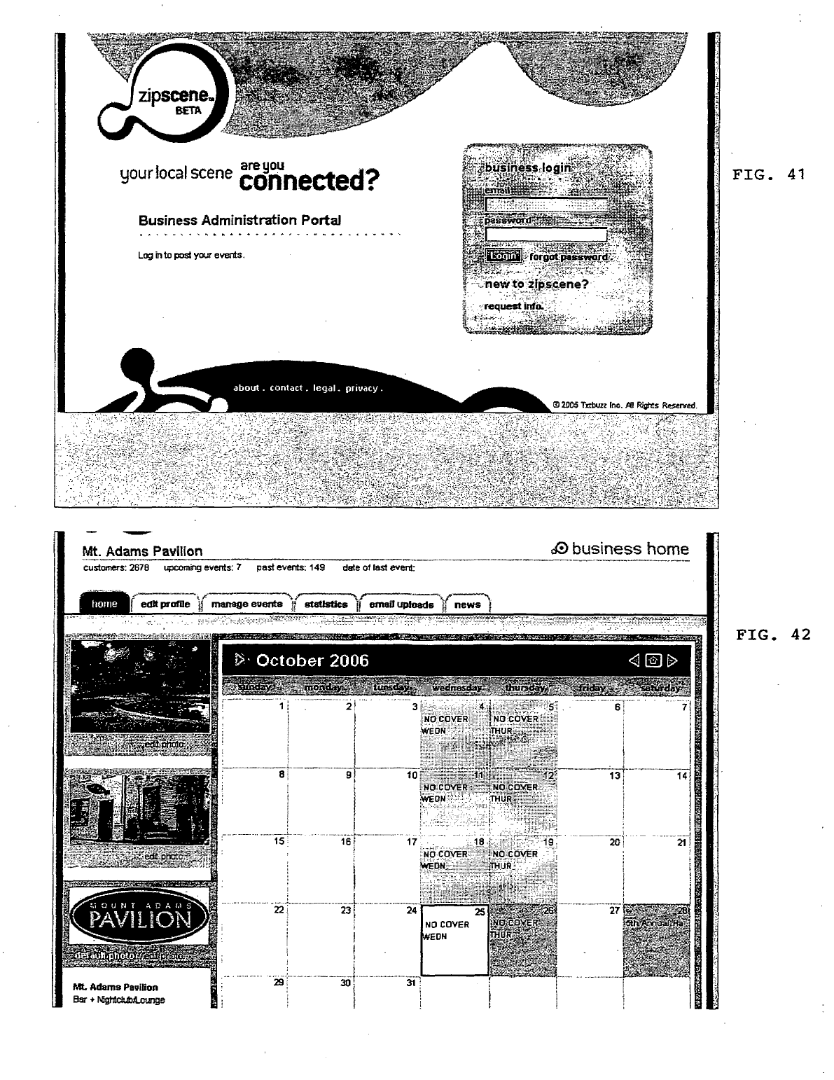

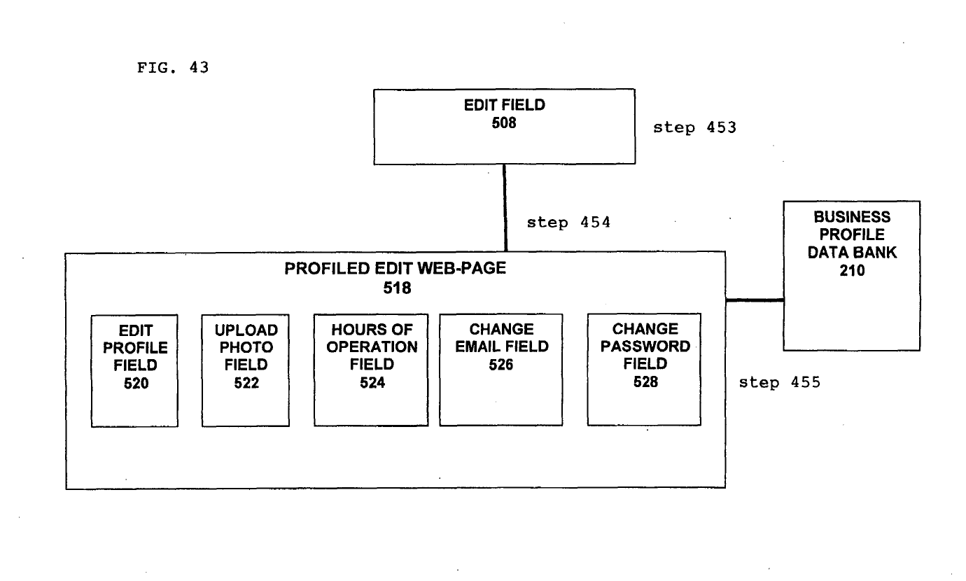

Referring to the FIGS. 3 and 40, the business module 204 and the administrative module 202 are shown whereby a business client first enters the business opening web-page 500 (e.g. HTML page) and to initiate the system, the business client using a business client computer 104 obtains access to the system server 106 via a network intercommunication 108 to visit the business client's website (step 449) within the system server 106. The system software 200 directs (step 450) the server 106 to display the business opening web-page 500 which provides a business administration portal 502 for allowing a business client to “login,” such as by operating to allow the business client to enter a specific Email address and password (step 451). Once the business client “logs in” the system software 200 operates to allow the business client access to secured web-pages that contain specific information relating to the particular business client. Initially, the system software 200 directs the system server 106 to display a “home” web-page 504 (e.g. HTML page) which preferably contains a business calendar 506 (step 452), as well as providing the business client with various field options including inputting, reviewing and editing the business profile, “edit profile” field 508; the upcoming and past events sponsored by the business, “manage events” field 510; the statistical breakdown of the benefits derived by its participation in the network, “statistics” field 512; the ability to contact individuals who may have an interest in becoming an individual member, “Email uploads” field 514; and review information concerning marketing opportunities with regard to the network, “news” field 516. The business calendar 506 is operated and maintained by the system software and permits the business client to review past and future scheduled events. Thus the business client can plan and schedule events and other promotional programs quickly and easily. The system software 200 also operates to allow the business client to add an event or an offer to its business calendar 506 by selecting the “add event” field 509 which when selected directs the system software 200 to list the event onto the business calendar 506. In a preferred embodiment, the business client is also able to identify a venue (which may be different than the business client's venue) that will hold the event. If the business client elects to identify such a venue, the system software 200 operates to list the event on the business calendar 506 of the business client adding the event and also on the business calendar 506 of the venue where the event is to be held. In another preferred embodiment, the system software 200 operates to direct the system server 106 to allow the business client's calendar to be linked to web-pages that are outside the network. For an illustrative example, once a business client has entered an event onto its business calendar, the business client using the system software can create a link on its own web-page (a web-page outside of the system 100) to its business calendar 506 such that a customer who accesses the business client's web-page can view the calendar. It should now be apparent to those skilled in the art that business clients utilizing the system 100 can update all of the event information contained on its various Internet web-pages (inside or outside the network) by simply updating its business calendar 506. Accordingly, business clients having various web-pages having business calendars or event/offer listings, can update them by simply updating the business calendar provided by the personal contact and marketing system 100. Preferably, in another preferred embodiment, once a business client enters an event onto its calendar 506, the entered event is automatically communicated by the system 100 to individual members, such as by adding the event to the calendar of an individual member who previously identified the business client to be of interest. In another preferred embodiment, once a new event or offer has been entered into the system by the business client, the system software operates to communicate the new event or offer to members within the community or to those members that have identified themselves as being interested in receiving information concerning the particular venue or that type of event or offer. For example, the event or offer can be communicated via Email, through an Internet blog, using instant messaging systems, or the like. In another preferred embodiment, individual members can receive periodic communications that inform them of new events and offers that have been entered into the system. In a preferred embodiment, the individual members will receive information only for events and offers that the individual member has identified, as previously described, of being of interest. FIGS. 41 and 42 are exemplary illustrations of an opening web-page 500 that can be generated by the system software showing a “log-in” (business administration portal) and a home web-page 504 showing a preferred business calendar 506, respectively.

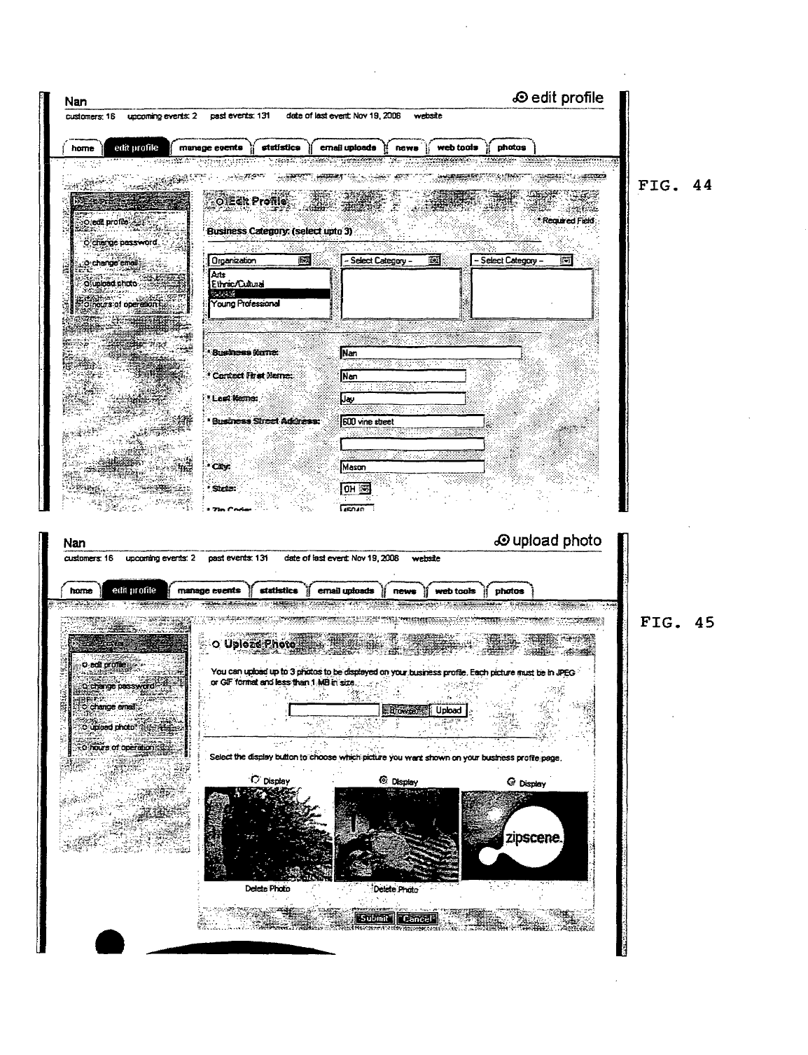

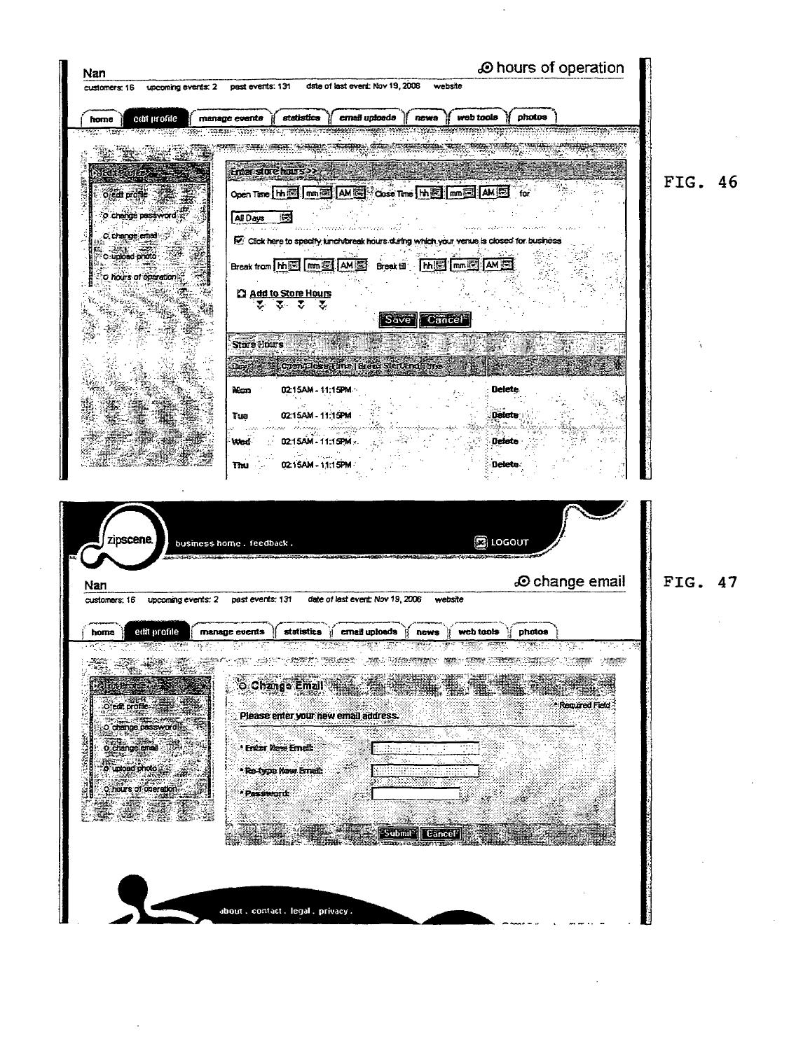

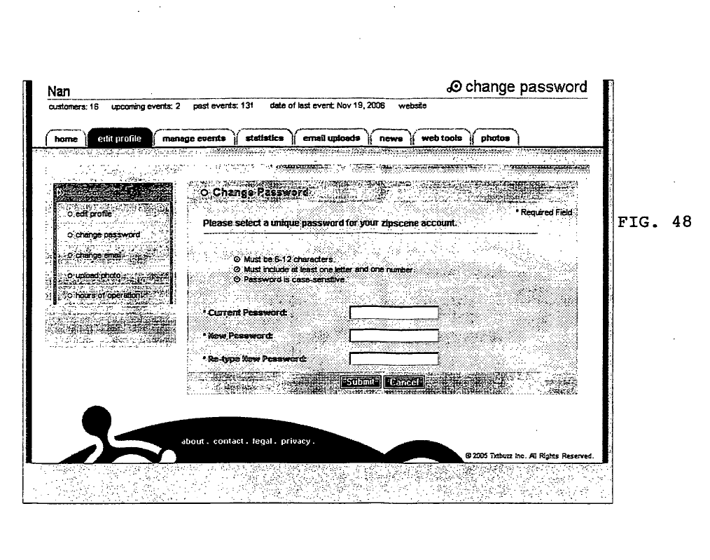

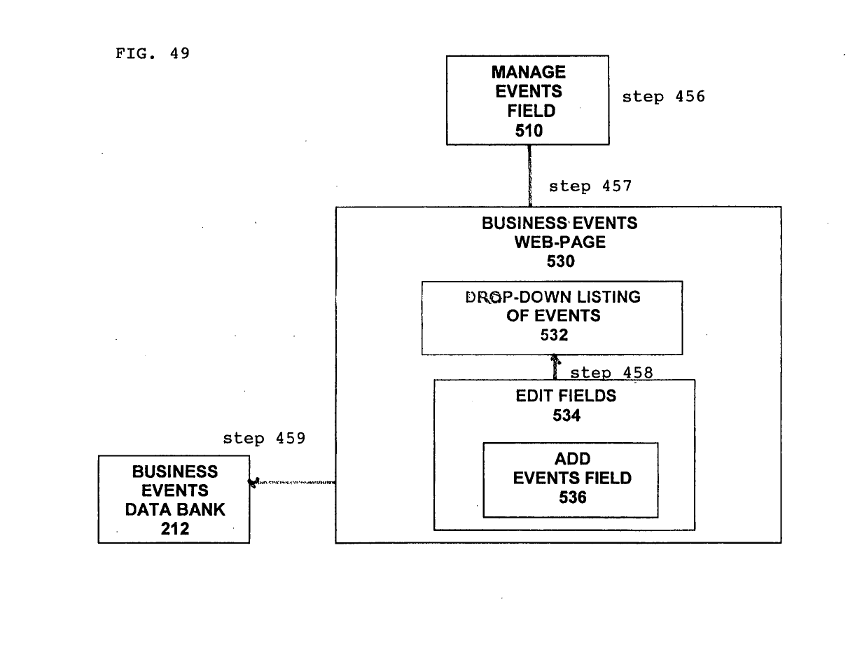

Referring to FIG. 43, upon request by the business client (step 453) by selecting the “edit profile” field 508, the system software 200 operates to automatically direct the system server 106 to display on the output of the business client's computer 104 a profile edit web-page 518 (e.g. HTML page) (step 454) having various fields, such as “edit profile” field 520, “upload photo” field 522, “hours of operation” field 524, “change Email” field 526 and “change password” field 528. In a preferred embodiment of the invention, such information includes business client's name, contact information, business address, phone and fax number, business URL address (web-page), exclusive offers, and the description of the business. The information is then stored (step 455) in the business profile data bank 210 of the memory 114 of the computer system 110 (FIGS. 1 and 3). Once the business client has entered its profile into the business profile data bank 210, individual users/members will have access to it by selecting the “venue” field 308 on the opening web-page 302. Preferably, the business client can return to the “home” web-page 504 or any other web-page by selecting the desired web-page field. FIG.44 is an exemplary illustration showing a profile edit web-page generated by the system software. In another preferred embodiment, the system software 200 operates to allow a business client to upload photographs to be displayed on the business client's profile. FIG. 45 is an exemplary illustration of an “upload photo” web-page generated by the system software 200 that shows how a business client can select and upload a photograph into the business client's profile stored in the business profile data bank 210. In another preferred embodiment, the system software 200 operates to allow other information to be inputted into the business client's profiles, such as business hours. As shown in an exemplary illustration of (FIG. 46) a web-page generated by the system software, a business client can enter business hours into the client's profile. In another exemplary illustrative, as shown in FIG. 47 of a web-page generated by the system software, a business client can change the client's Email address or its security password (FIG. 48) for allowing the business client access to its profile and private information stored in the system server.

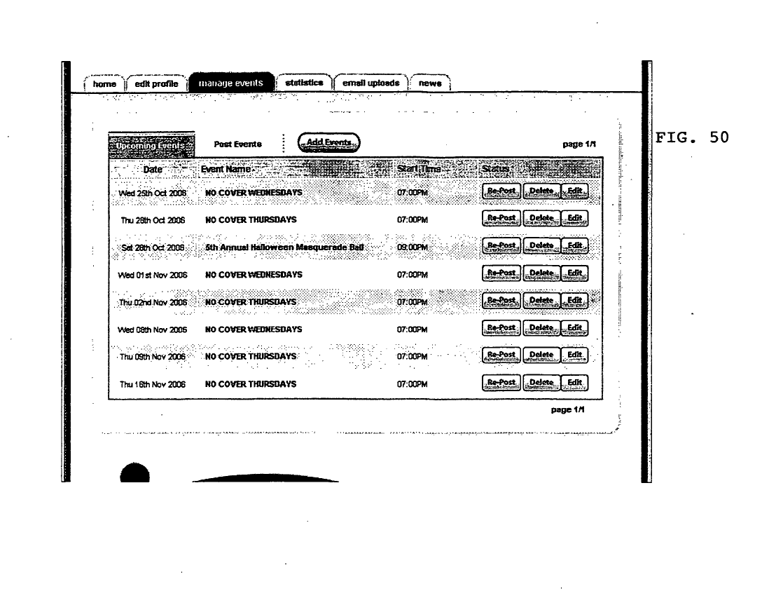

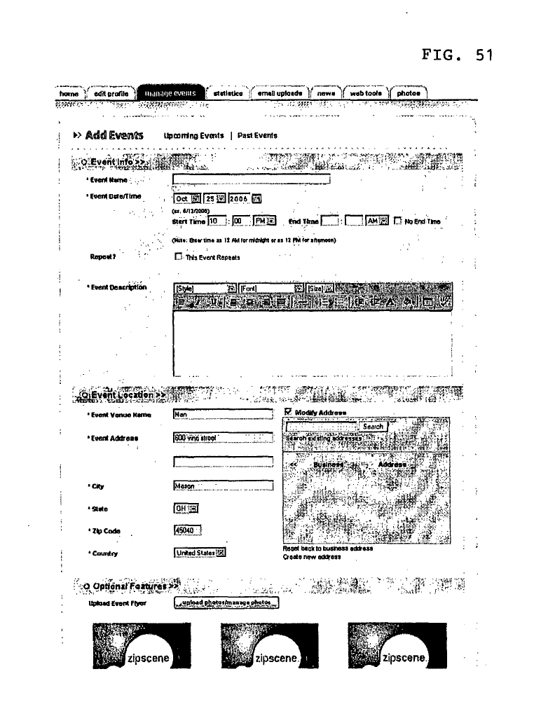

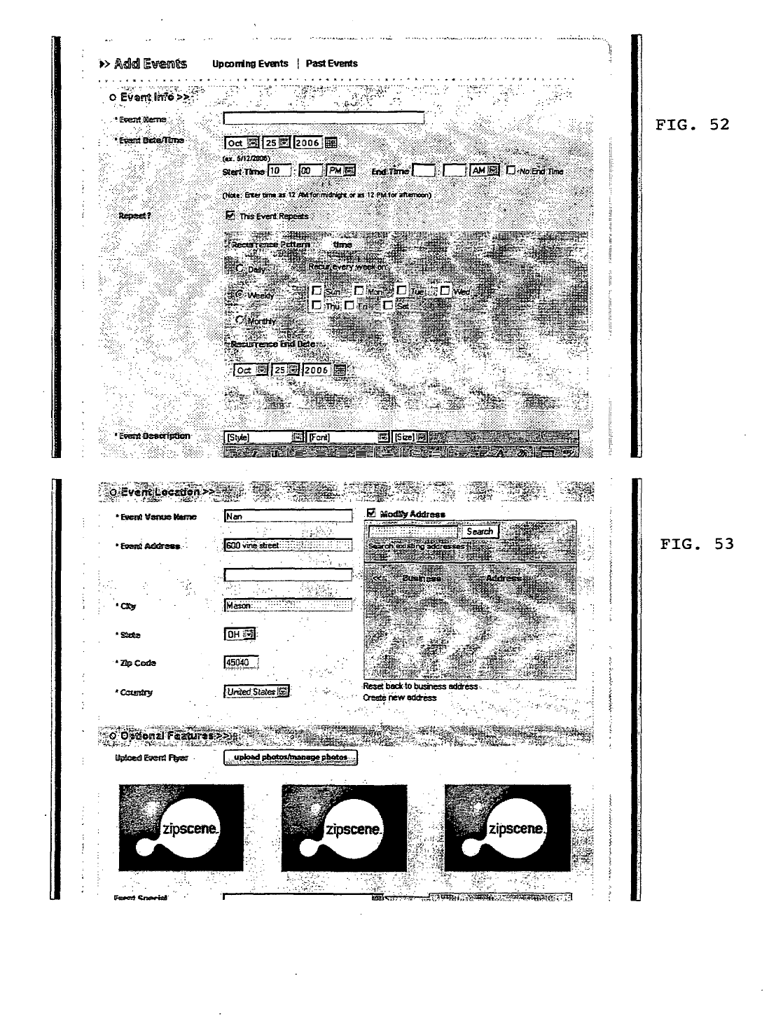

Referring to FIG. 49, upon request by the business client (step 456) by selecting the “manage events” field 510, the system software 200 operates to automatically direct the system server 106 to display on the output device of the business client's computer 104 a business events web-page 530 (e.g. HTML page) (step 457) having a drop-down listing 532 of all events previously entered by the business client and stored in the business information data bank 212 (step 459) of the memory 114 of the computer system 110 (FIGS. 1 and 3). Preferably the business information web-page 530 has “edit” fields 534 that when selected directs the system software 200 (step 458) to allow the business client to add (as described above), re-post, delete, or edit a particular event listing. Preferably the user can return to the “home” web-page 504 or any other web-page by selecting the desired web-page field. Such added or edited information is then stored in the business information data bank 212. Once the business client has entered an event into the business information data bank 212, individual users/members will have access to information concerning the event stored in the business information data bank 212 by selecting the “events” field 306 for displaying the events web- page 334. FIG.50 is an exemplary illustration showing a business events web-page 530 generated by the system software 200. As shown in FIG. 50, the system software 200 allows a business client to enter events into the system by selecting the “add events” field 536. Upon selection, the system software operates to generate web-pages having dialogue boxes and inputs for the business client to enter event information. Exemplary illustrations of web-pages for inputting event data into the system are shown in FIGS. 51, 52 and 53.

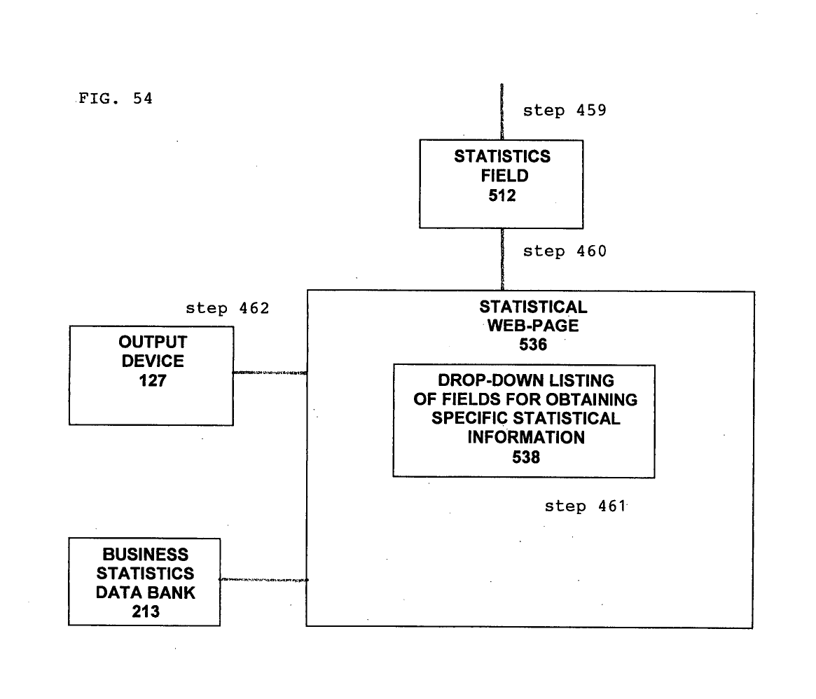

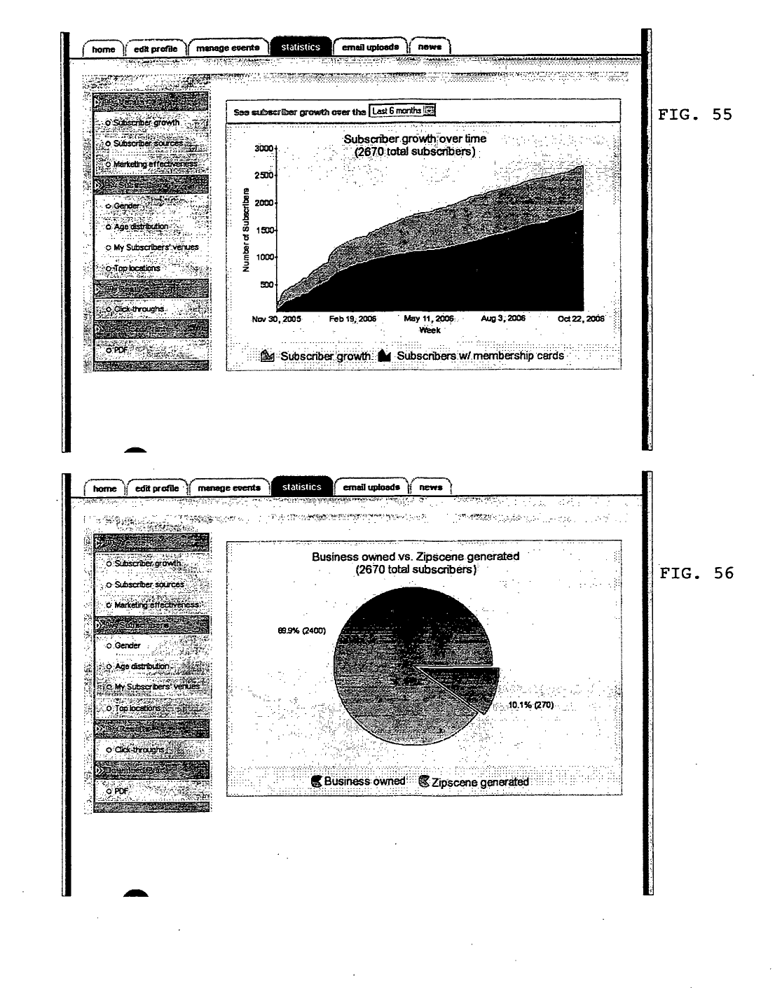

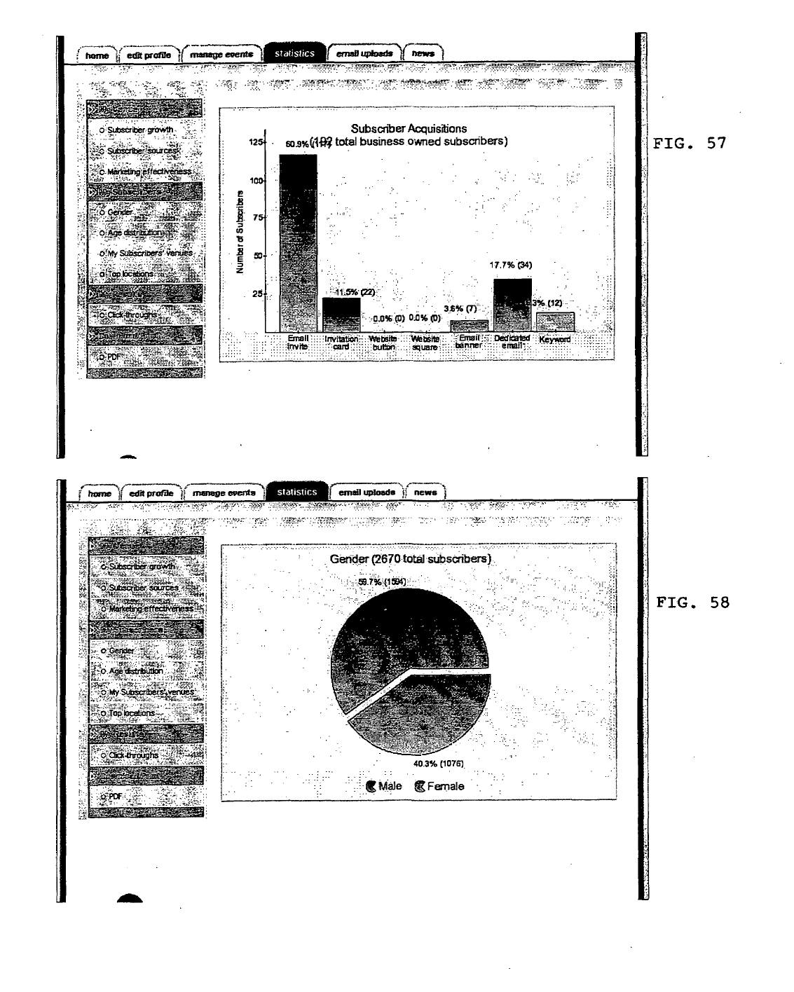

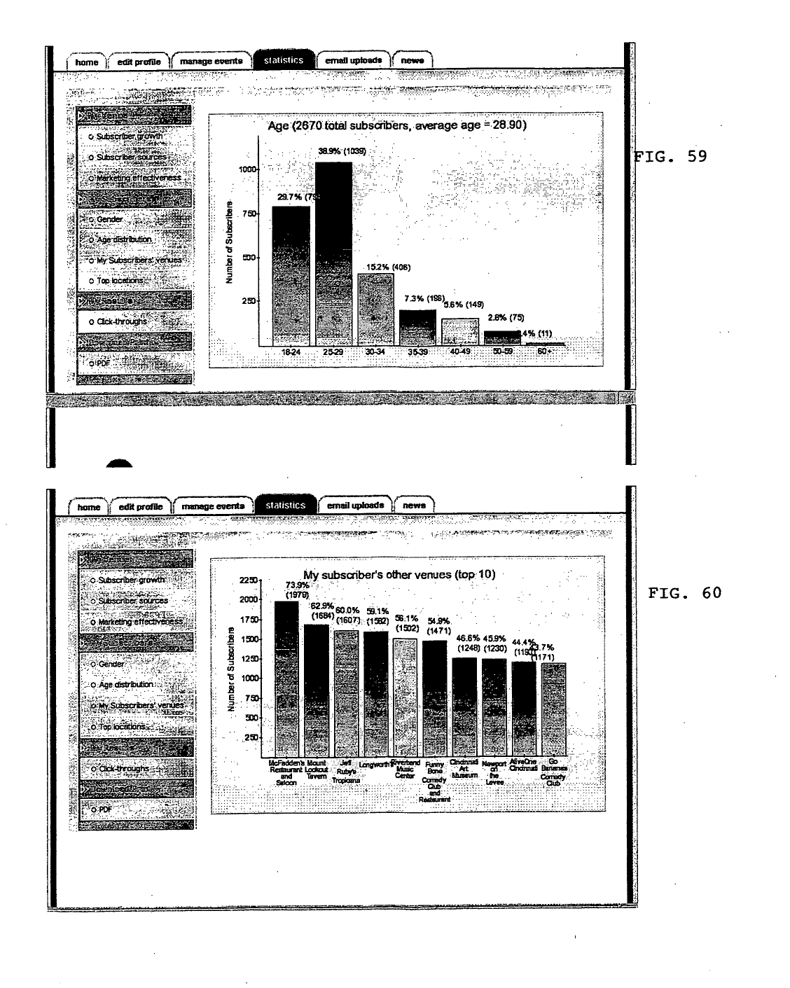

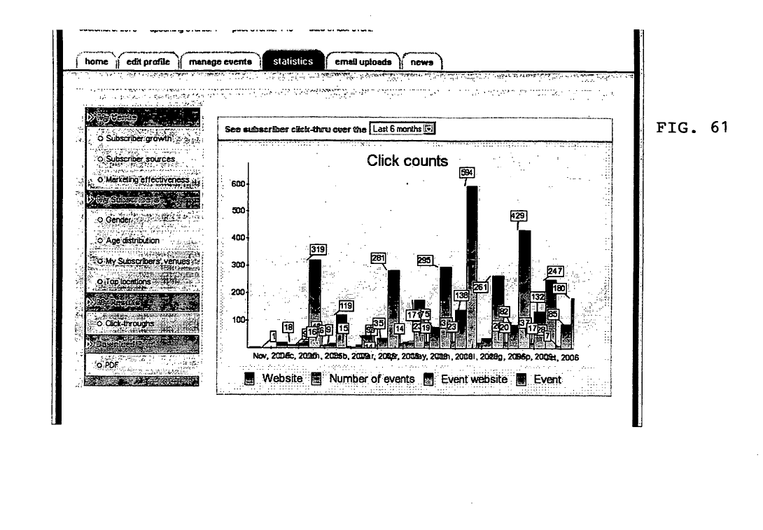

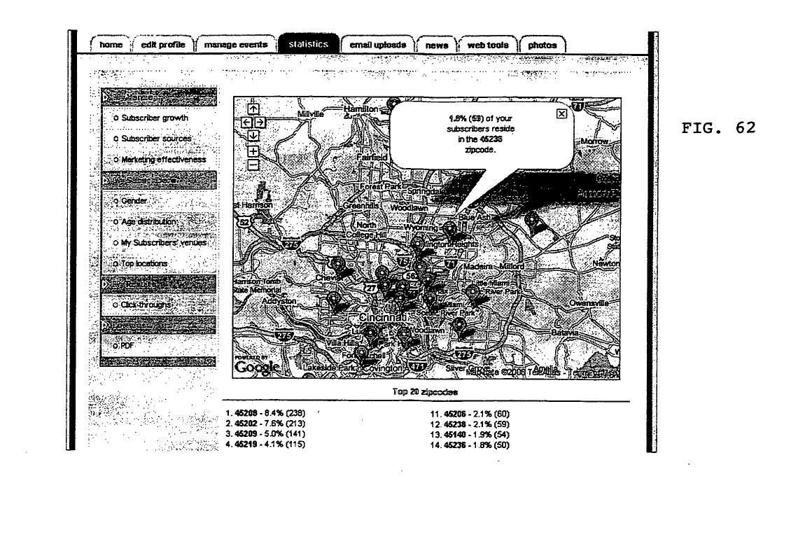

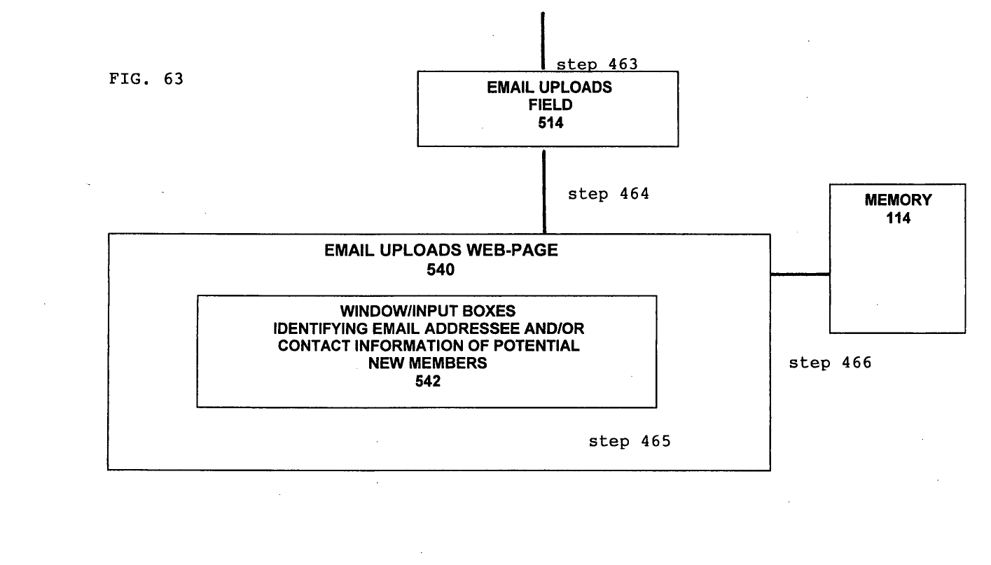

Referring to FIG. 54, upon request by the business client (step 459) by selecting the “statistics” field 512, the system software 200 operates to automatically direct the system server 106 to display (step 460) on the output device 127 of the business client's computer 104 a statistical web-page 536 (e.g. HTML page) containing various fields 538 for obtaining specific statistical data concerning the effectiveness of the personal contact and marketing system 100. When a specific field 538 is selected by the business client, the system software 200 is directed to and generates specific statistical data (step 461) which is displayed (step 462) on the output device 127 of the particular business computer 104 for review by the business client. Using means for generating statistical data, such as conventional web-site activity tracking means, the system software tracks and stores in the business statistics data bank 213 the number of times a system web-site is accessed by a user/member. In addition, the system operates to track other data such as the particular venues and/or events a user/member identifies of being of interest, the number of “friends” contacted by the user/member and the venue and event information forwarded to such “friends, including views, forwards, add to calendar, and invitations to “friends” made by individual members of the network with regard to the particular business client, the number of new individual users joining the network and how the user became a member (such as by invitation from a business, and the particular business making the invitation), the events attended by individual members, and other such statistical data. In addition, the system software further operates to correlate such data with specific information pertaining to the member (profile information). Accordingly, statistical data can also be conventionally constructed based on user/member demographics. In another preferred embodiment, the system further operates to identify those individual members that have identified the largest number of “friends” or have the greatest impact of events (such as for example attending particular events with relatively large number of friends). Such information can then be provided to business clients for marketing purposes. For example, once identified such individual members can be contacted by business clients and given special promotional offers. Preferably, the statistical information generated by the system software can be displayed in numerical form, graphical form, or both. Preferably, the user/member can return to the “home” web-page 504 or any other web-page by selecting the desired web-page field. FIGS. 55 through 61 are exemplary illustrations showing a statistical web-page 536 displaying some of the statistical data derived by the system, such as subscriber growth (number of new members) over time (FIG. 55), membership sources (FIG. 56), marketing effectiveness (FIG. 57), demographic data, gender (FIG. 58), age (FIG. 59), subscriber locations (FIG. 60), “clicks” for particular events (FIG. 61), and members geographic information (FIG. 62).

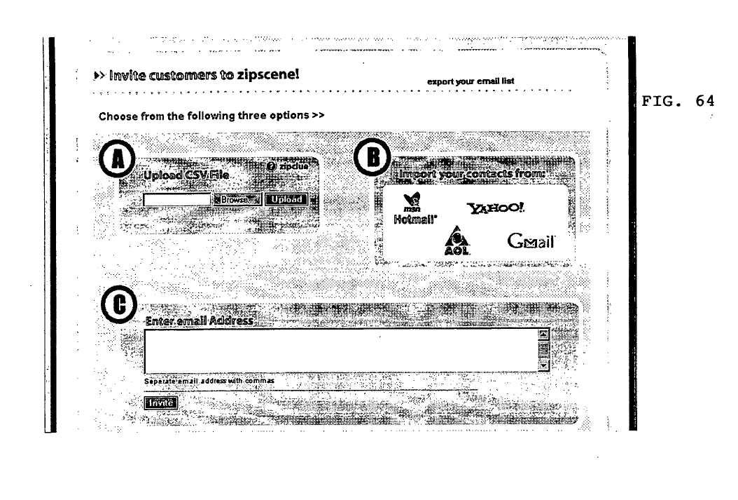

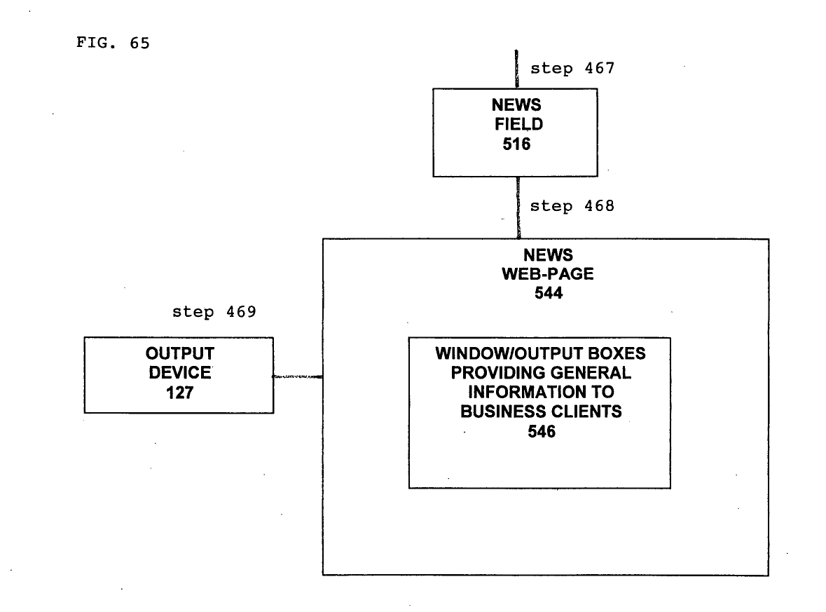

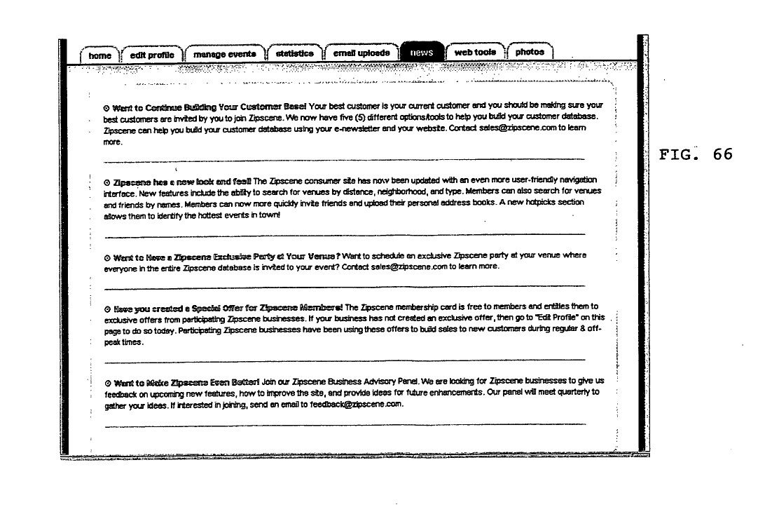

Referring to FIG. 63, upon request by the business client (step 463) by selecting the “Email uploads” field 514, the system software 200 operates to automatically direct the system server 106 to display on the output device 127 of the business client's computer 104 an Email uploads web-page 540 (e.g. HTML page) (step 464) containing window or input boxes.542 which permits business clients to identify the Email addresses or other contact information of potential new individual members (step 465) which are then stored in the memory 114 of the computer system 110 (step 466). Such potential individual members can then be contacted, such as by a system administrator, to determine their interest in membership in the network 100. Preferably, the business client can return to the “home” web-page 504 or any other web-page by selecting the desired web-page field. FIG. 64 is an exemplary illustration showing an Email uploads web-page 540.

Referring to FIG. 65, upon request by the business client (step 467) by selecting the “news” field 516, the system software 200 operates to automatically direct the system server 106 to display (step 468) on the output device 127 of the business client's computer 104 a news web-page 544 (e.g. HTML page) (step 469) containing window or output boxes 546 which permits the network administrators to provide business clients with general information and suggestions and other information concerning the network, the community, or information pertaining to or relating to the personal contact and marketing system 100. Preferably, the business client can return to the “home” web-page 504 or any other web-page by selecting the desired web-page field. FIG. 66 is an exemplary illustration showing a news web-page 544 generated by the system software.

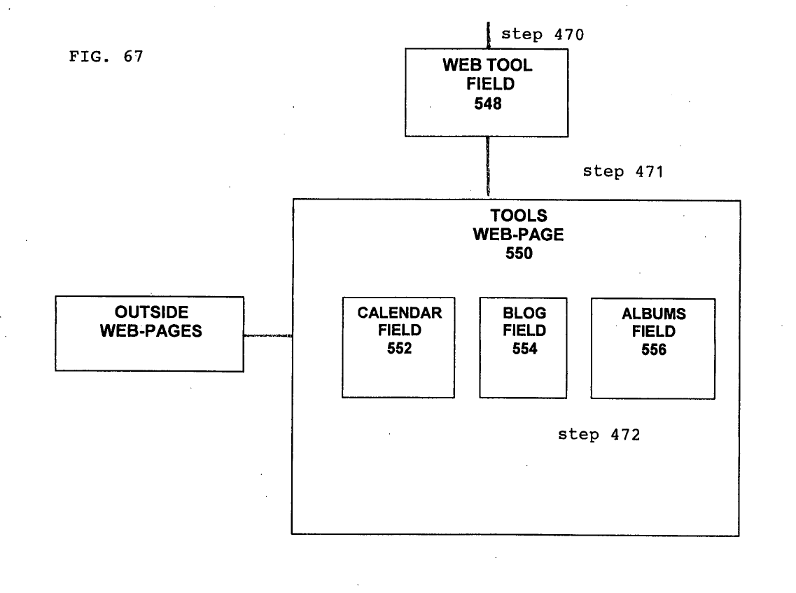

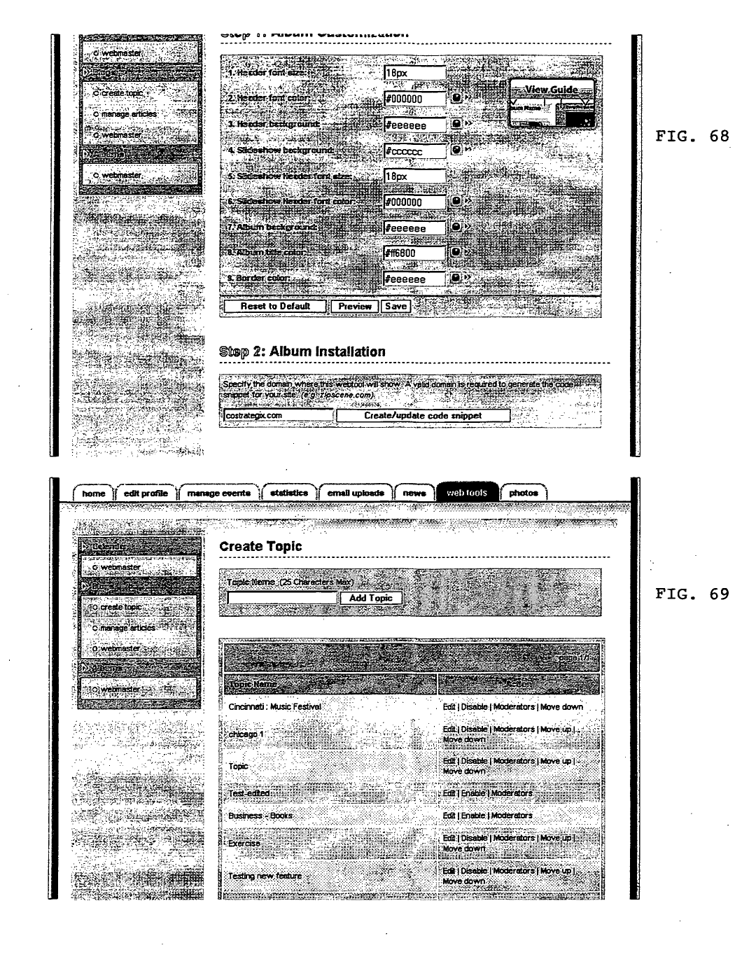

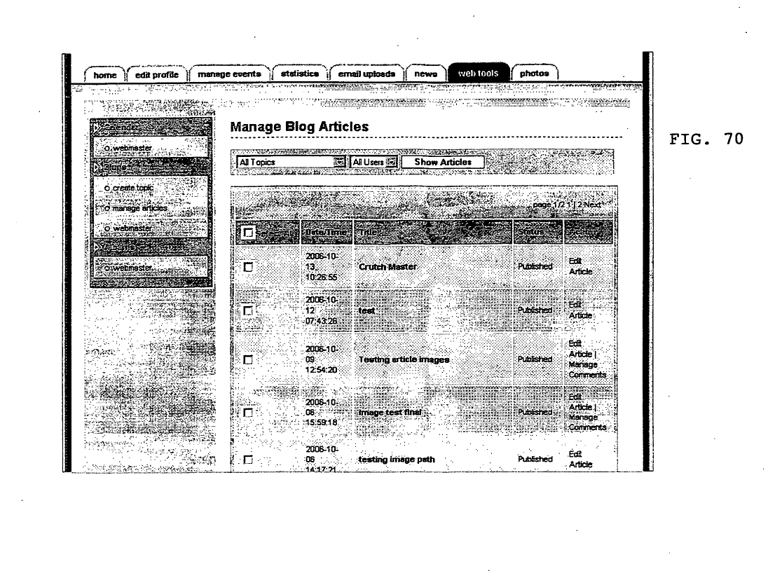

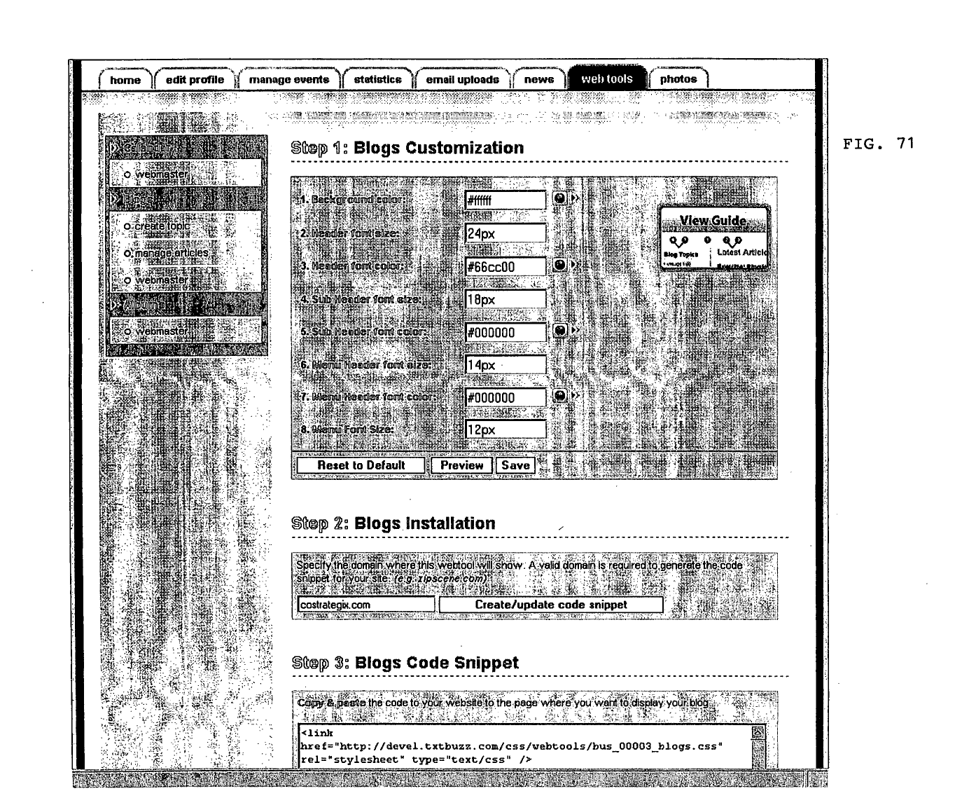

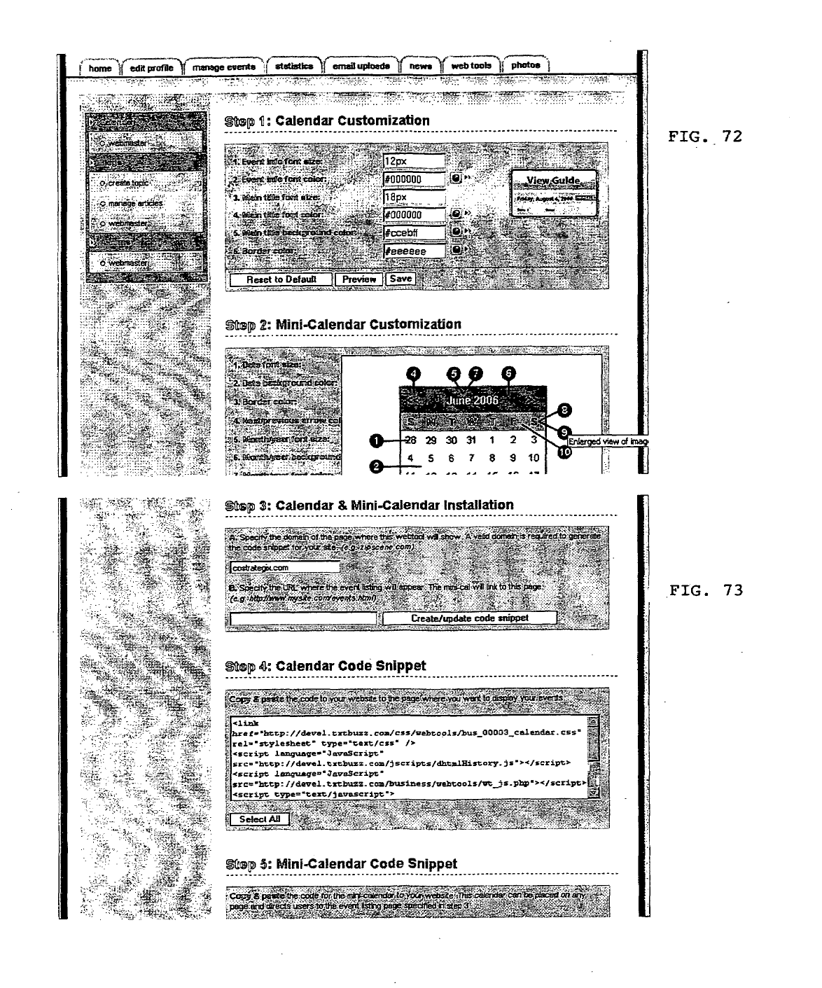

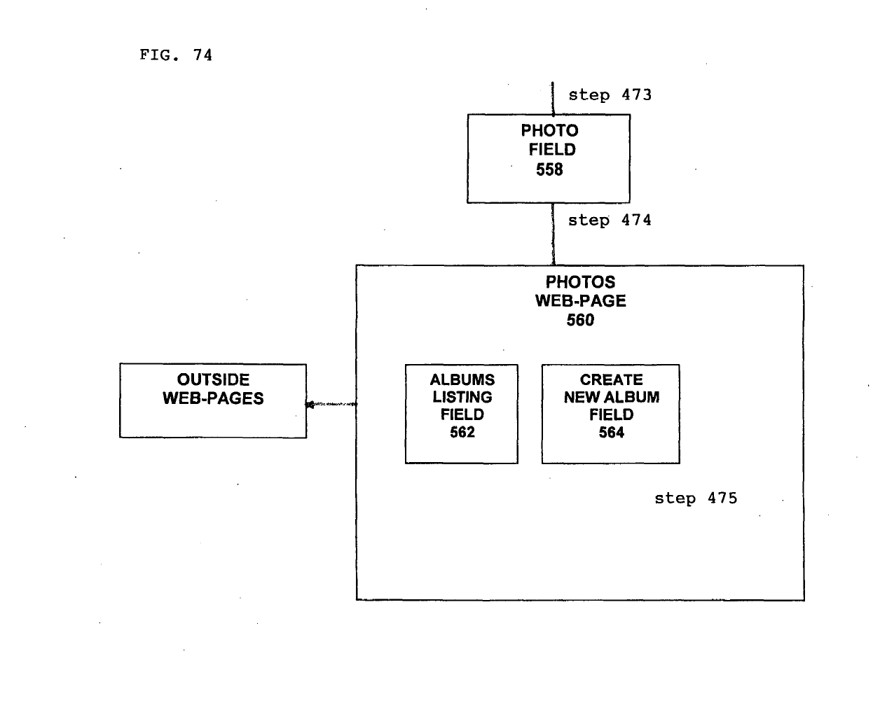

Referring to FIG. 67, upon request by the business client (step 470) by selecting the “web tools” field 548, the system software 200 operates to automatically direct the system server 106 to display (step 471) on the output device 127 of the business client's computer 104 a “tools” web-page 550 (e.g. HTML page) containing various fields for creating, updating and modifying calendars (“calendar” field 552), blogs (“blog” field 554), and photographs (“albums” field 556) which can then be linked or pasted to a business client's personal web-page. In this way a business client by selecting the desired field (step 472) can easily manage content on the business client's personal web-page. FIG. 68 is an exemplary illustrative web-page generated by the system software 200 showing how a business client can customize the appearance of a photograph album to be displayed on the business client's profile or pasted or linked to the business client's personal web-page. FIGS. 69, 70 and 71 are exemplary illustrative web-pages generated by the system software 200 showing how a business client can create a blog topic, manage blog articles to be displayed on the business client's profile, or customize and paste or link the article to the business client's personal web-page (inside or outside of the network). FIGS. 72 and 73 are exemplary illustrative web-pages generated by the system software showing how a business client can create and customize the appearance of a business calendar which can be pasted onto the business client's personal web-page or displayed on the system.

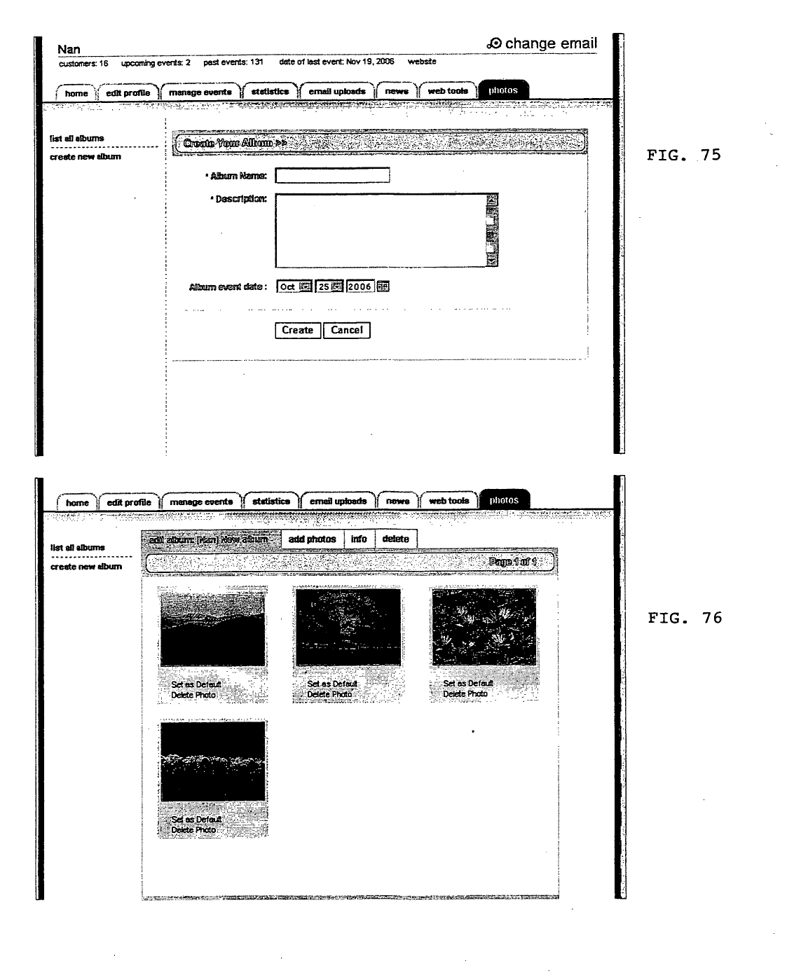

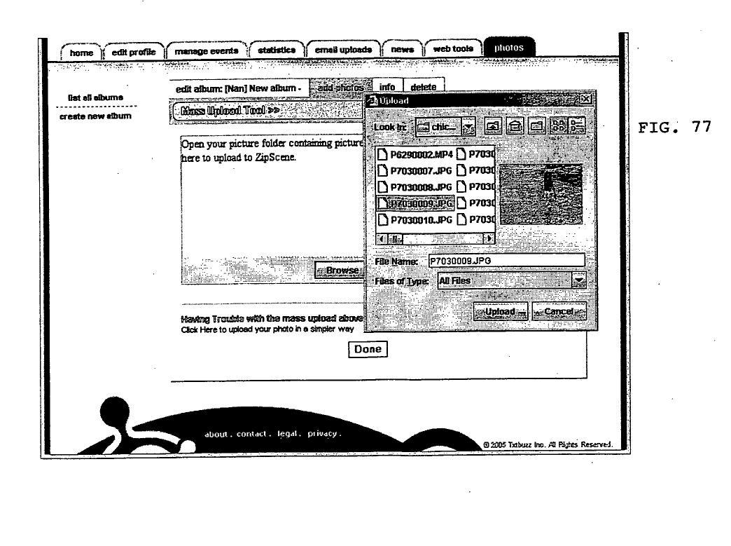

Referring to FIG. 74, upon request by the business client (step 473) by selecting the “photos” field 558, the system software 200 operates to automatically directs the system server 106 to display (step 474) on the output device 127 of the business client's computer 104 a “photos” web-page 560 (e.g. HTML page) containing an “album listing” field 562 and a “create new album” field 564 which when selected by the business client (step 475) directs the system software 200 to display to the business client previously created albums or operates to allow the business client to create, and upload photograph albums, such as photographs of past events, which can then be linked or pasted to a business client's personal web-page. FIG. 75 is an exemplary illustrative web-page generated by the system software displaying means by which a business client can create and enter into the system a photograph album to be displayed on the business client's profile or pasted or linked to the business client's personal web-page. FIGS. 76 and 77 are exemplary illustrative web-pages generated by the system software showing how a business client can edit a photograph album and upload an album, respectively, to be displayed on the business client's profile or pasted or linked to the business client's personal web-page.

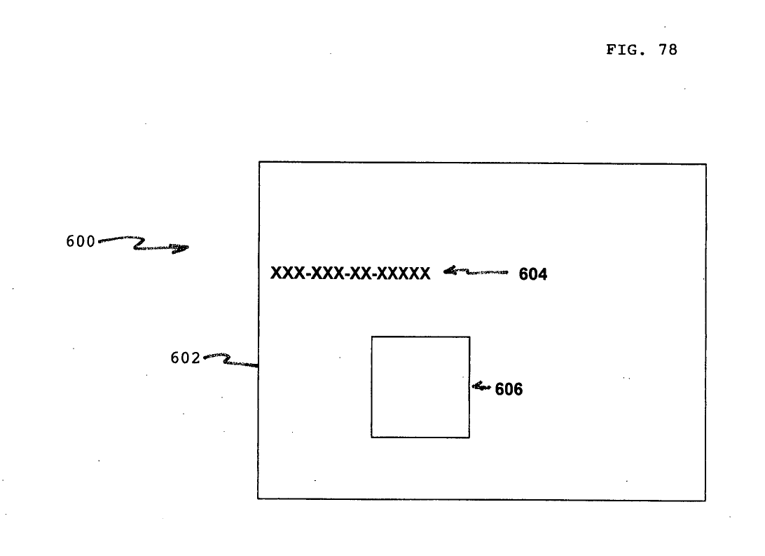

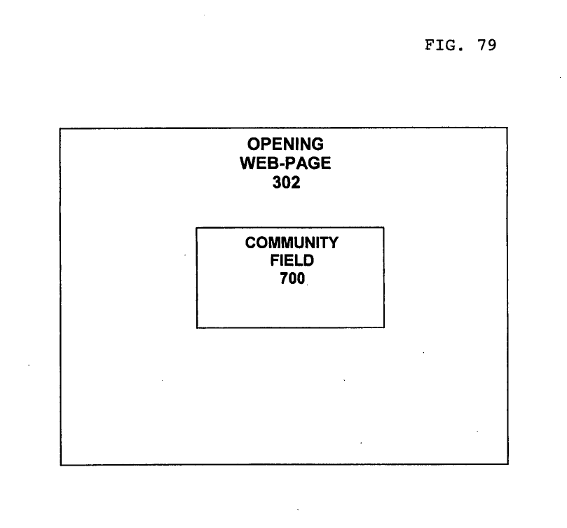

Referring to FIG. 78, in another preferred embodiment of the invention, the system further comprises an off-line marketing means and method for inviting individual users to participate in the network and become members. In a preferred embodiment, such marketing means 600 may include separate member identification means 602, such as a membership card, that operates to allow the individual member to participate in the network. In a preferred embodiment, the identification means 602 includes a membership identification number 604 and are encoded with information about the user (“profiles”) such as by means of a UPC or magnetic strip 606 thus allowing a business client to create and implement frequency marketing programs, loyalty programs, best customer programs, and the like. Business clients can then track the profiles of such customers on both an individual and an aggregate basis. In another preferred embodiment, members may use the identification means 600 to receive special offers from participating business clients. Such business clients can create their own special offers for members and honor those offers when members display their identification means 602 when visiting the venue, thus encouraging trial, repeat, and/or volume purchase. Preferably, by using such off-line marketing means, individual users when they register themselves using the system to become members can qualify for special offers. Such identification means 602 can be obtained by individual members such as by requesting a card using on-line means, such as by accessing system via the Internet and filling out the appropriate window or dialog boxes provided on a displayed web-page, such as an opening web-page, or by manually filling out a written request form or an invitation to join or receive the identification means form and conventionally sending it to the system administrator for processing. Each business client may also be assigned one or more invitation code(s) 330 that is listed on each identification means application given out to an individual by a particular business. If an individual user elects to request the marketing means 600 via the Internet, as shown in FIG. 4, when the user applies for membership into the network 100 and/or when requesting the identification means 602, the user can enter the particular invitation code 330. The particular member is then tracked in the system along with the particular invitation code 330. This tracking can then be used to provide statistical information to the business clients. In a preferred embodiment of the invention, the identification means includes a tracking means, such as an individual bar code, that can be recorded into the system each time the identification means 602 is used. It should now be apparent to those skilled in the art that by such recorded information will provide business clients the ability to determine those members who frequent their establishments and the events they attend. Further, the system having input from a variety of business clients can provide certain statistical information, such as the events attended together with relevant demographic data, to allow business clients to analyze the type of events that are of interest to specific customer bases. Further, business clients can identify those individual members who frequent their business and provide additional promotional incentives.

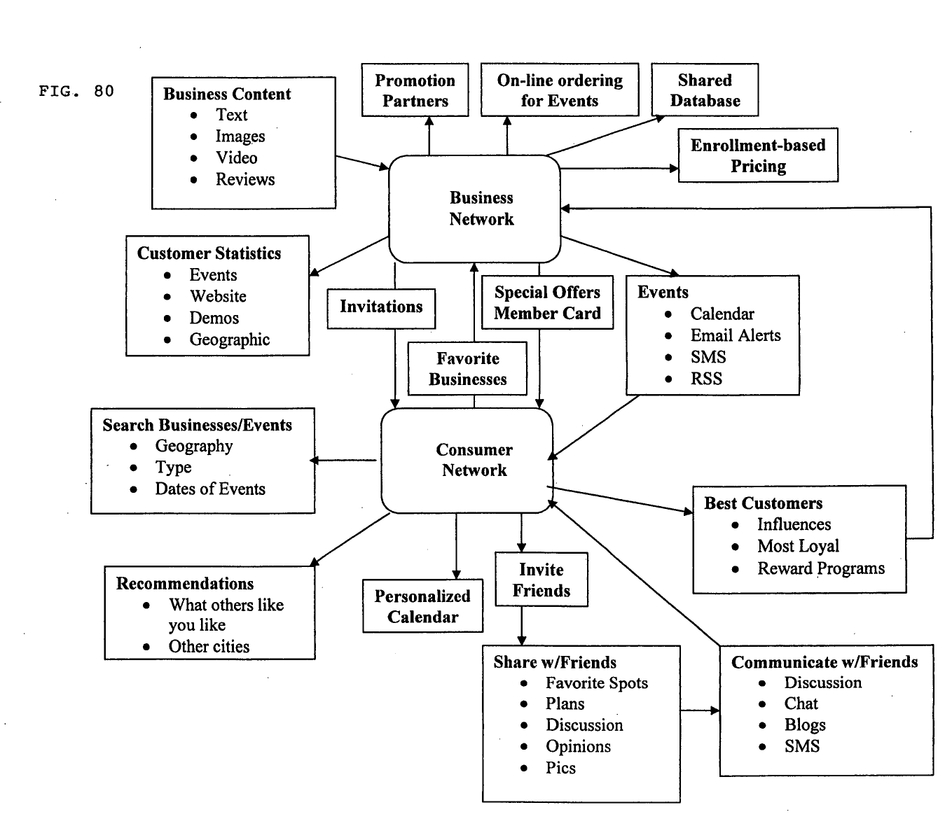

It should now be understood that the personal contact and marketing system described herein is not limited to one particular community, but can operate throughout a plurality of communities within the network. Other communities, such as for example, communities can be established in other cities and regions can form the network. Users/members can gain access to such other communities within the network by simply selecting the “community” field 700, such as on the opening web-page 302 generated by the system software 200 (FIG. 79) which then directs the system software 200 to give the user/member access to the selected community. In this way, a user/member, using the method previously described, can review venues and events within that selected community and in a preferred embodiment an individual member can create additional calendars each directed to a different specific community. Thus, business travelers, vacationers, and the like can use the system to make plans and schedule activities when visiting the area served by that community. In another preferred embodiment, the member can identify “friends” within that community to be placed within the neighborhood of that community.

Referring to the various figures, and more particularly to FIG. 80, as previously described, it should now be apparent that the personal contact and marketing system of the subject application provides a means whereby individual users/members and businesses (venues) can interact within a network. In operation, in a preferred embodiment the personal contact and marketing system of the subject application provides means whereby individual users/members can search for business venues and event information using various search parameters such as by name, geography, type, date, etc. which are displayed on the users output device. Users can choose to subscribe to the network and use the system to receive information about particular businesses (venues) and receive event and promotional information for that venue. The system also allows such users/members to identify specific venues that participate in the network to receive notices of upcoming events and promotional offers that pertain specifically to those venues. Using the system, the user/member can easily obtain additional information concerning the event displayed, including reviewing events that are considered to be the most popular based on network activities, such as based on total number of members requesting information on the event, number of members forwarding event information to other members, size of the event, and other such criteria. It should now be apparent that the personal contact and marketing system described herein provides a means whereby businesses can significantly increase its exposure to potential new customers and can direct its marketing activity to those individuals that have acknowledged an interest in that business (venue) or in services or products that are offered by that business (venue).

It should also now be apparent that the benefits of the personal contact and marketing system is not limited to entertainment type businesses but can be of equal benefit to other types of businesses. For example, the system described herein can also operate to provide marking and promotional opportunities to businesses selling products (such as for an example retail businesses) or providing various types of services (such as for an example hotels and travel services). Further, information entered into and stored in the system can be pasted, linked or otherwise transferred to outside electronic media, such as for an illustrative example, to other servers for display on other websites and web-pages.

It should also now be apparent that by using the system, individual members can also create a personalized calendar that lists various events being offered by venues selected by the individual member which and be easily reviewed by the member. In another preferred embodiment of the invention, the individual member can receive such event information through a variety of sources, including their personalized calendars, Email, SMS/text messages, RSS feeds, and other like means, and can forward such information to “friends” or others in the community. In another preferred embodiment of the invention, individual members can create personal profiles, including posting photographs, and share such profiles with “friends” and other individual members within the network. In another preferred embodiment of the invention, individual members can invite “friends” to private parties or events and track responses. In another preferred embodiment of the invention, users/members can search for information concerning individual members, such as by name, Email, similar interests, geographic proximity, and other like criteria. The system also allows members to communicate generally through various means including chat rooms, Blogs, SMS, text messages, and other like electronic medium means.

It should also now be apparent that the system provides business clients, like social venues, the ability to create effective business profiles, that can include various types of content, including website links, graphical images, streaming video, audio, and other Internet-ready content. Such profiles can also include specific event information, such as date, event time, description, images and other such information which are stored within the system for easy viewing by individual users and members. In a preferred embodiment, the system provides each business client a calendar whereby an event or multiple events can be created, edited, and posted thereby allowing the business an effective and easy way of organizing events and activities. Further, the system tracks and stores statistic information and allows business clients to communicate with members who have identified the business of being of interest and provide them with information about upcoming events and special promotional offers. Further, the system operates to identify members having common interests thereby allowing a business client to target specific customers, such as individual members, new members, potential members, repeat customers, and the like. In another preferred embodiment of the invention, a business client can create and manage electronic transactions, such as taking reservations, selling tickets, merchandise, and the like by utilizing the communication network created by the system. Thus, businesses utilizing the system and method of the subject application can now easily create effective marketing and promotional programs to promote their business to consumers. Businesses can create, edit, and post information about their business and events using simple on-line web-based tools. The system further allows businesses to create and publish special offers targeted at acquiring new customers, reward current customers, and build customer loyalty. Through the use of off-line marketing means, businesses can provide other incentives to customers and similar businesses can benefit from information obtained by other businesses within the network.

It should also now be apparent that the system provides businesses with real-time access to statistics that can be used to analyze their customer and marketing efforts. Customer analysis includes, but not limited to, statistical data with respect to member/user demographic data, tracking membership growth and the source of the growth, event-specific statistics, including the number of users reviewing event information, forwarding information to friends, events being added to individual member calendars, and invitations made to “friends.”

It should also now be understood to those skilled in the art that the various web-pages described herein may be conventionally created having prompt, dialog, and entry windows that conventionally guide a user to enter and obtain information and may be conventionally linked together such as they operate together as described herein.

The personal contact and marketing system of the subject invention provides a structured methodology and design utilized by the system software and is not limited solely to the specific design of the software. Although the foregoing invention has been described in some detail for purposes of clarity of understandings, it will be apparent that certain changes and modifications may be practiced within the scope of the appended claims. It should now be apparent that the various embodiments presented can be easily modified while keeping within the scope and spirit of the subject invention. Accordingly, it should be understood that the present disclosure is to be considered as exemplary of the principals of the invention and is not intended to limit the invention to the embodiments and the specific examples illustrated and the invention is not to be limited to the details given herein, but may be modified within the scope and equivalents of the descriptions and examples contained herein.

What is claimed is:

1. A personal contact and marketing system for providing a network allowing a plurality of users and a plurality of venues to interact, whereby the system comprises:
means for entering, storing, and retrieving information;
means whereby each of the plurality of venues can enter and store business and event information; and
means whereby each of the plurality of users can retrieve said business and event information;
wherein the system includes means for tracking the information being retrieved by said plurality of users.

2. The personal contact and marketing system of claim 1 further comprising means whereby each user can enter and store personal information; and
an interactive calendar effective for allowing each user to schedule activities and events thereon.

3. The personal contact and marketing system of claim 1 further comprising means for allowing users to form communities and message other users within said community.

4. The personal contact and marketing system of claim 3 further comprising means for allowing users to invite other users within a community to participate in a social activity.

5. The personal contact and marketing system of claim 1 further comprising means for users to acknowledge their intent to participate in a social activity to other users.

6. The personal contact and marketing system of claim 1 further comprising means for users to create personal profiles for view by other users.

7. The personal contact and marketing system of claim 1 further comprising means for allowing a venue to send information to users who are identified as being interested in such information.

8. The personal contact and marketing system of claim 1 further comprising means for generating statistical data.

9. The personal contact and marketing system of claim 1 further comprising means for allowing a user to purchase goods and event tickets from a business.

10. The personal contact and marketing system of claim 1 wherein each said venue can transfer information stored in the system onto a web-site located outside of the network.

11. A personal contact and marketing system for use by more than one individual user and more than one business client comprising:
a computer system having a processor and a computer-readable medium having computer-readable instructions for performing a method of operating the system and wherein said computer is linked to more than one input/output device to permit each individual user and each business client to communicate, and wherein said computer-readable medium when executed by said processor directs the processor to receive information and to transmit information in real-time to at least one individual user and to at least one business client;
means for each business client to store venue and event information relating to the business client;
means for each individual user to store information about the individual user;
means for linking the means for each business client to store venue and event information relating to the business client with said means for each individual user to store information about the individual user such that each individual user can have access to venue and event information relating to each business client and each business client can have access to information about each individual user.

12. The personal contract and marketing system of claim 11 further comprising an interactive communications interface having an interactive calendar on which at least one individual user can schedule activities.

13. The personal contact and marketing system of claim 11 further comprising an interactive communications interface having an interactive calendar on which a business client can schedule events thereon.

14. The personal contact and marketing system of claim 13 wherein said business client can transfer a copy of said calendar to an outside electronic medium.

15. The personal contact and marketing system of claim 11 wherein information stored in the system by a business client can be copied to an outside electronic medium.

16. The personal contact and marketing system of claim 11 further comprising an interactive communications interface having means for posting messages by the individual users.

17. The personal contact and marketing system of claim 11 further comprising an interactive communications interface having means for instant messaging between individual users.

18. The personal contact and marketing system of claim 11 further comprising means for generating statistical data.

19. The personal contact and marketing system of claim 11 further comprises at least one Internet web-site having a plurality of web-pages providing an interactive, menu and event driven system that cooperates with a system server for using prompt, dialog, and entry windows to guide a user to enter or obtain information.

20. The personal contact and marketing system of claim 19 wherein said means for generating statistical data includes a conventional web-site tracking means effective for tracking and storing the number of times the system web-site is accessed by a user.

21. A personal contact and marketing system for forming a network for use by one or more individual users and one or more business clients comprising:
a server;
at least one web-site having a plurality of web-pages and residing on said server;
a computer system linked to said server and having software that cooperates with said server to provide interactive communications between individual users and between individual users and business clients;
at least one data bank for storing information;
wherein information about a business venue and events can be stored in at least one data bank and can be accessed by individual users through one or more of said web-pages;
wherein said computer system operates to track and store statistical data in said data bank and can be accessed by business clients through one or more of said web pages.

22. The personal contact and marketing system of claim 21, wherein said web-site provides an interactive calendar on which individual users can schedule activities.

23. The personal contact and marketing system of claim 21, wherein said statistical data includes the number of times each of at least one of said web-site is accessed by the individual users, the number of new individual users joining the network and how each of the new individual users joined the network, and for each business client the particular venues and events the individual users have identified of being of interest, the number of other users contacted by the individual users, the venue and event information forwarded by the individual users, the events that the individual users expect to attend, the number of invitations to friends made by individual users, and the events attended by individual users.

24. The personal contact and marketing system of claim 21 further comprising means for allowing individual users to form communities within the network and message other users within said community.

25. The personal contact and marketing system of claim 24 further comprising means for allowing individual users to invite other individual users within a community to participate in a social activity.

26. The personal contact and marketing system of claim 21 further comprising means for individual users to acknowledge their intent to participate in a social activity to other individual users.

27. The personal contact and marketing system of claim 21 further comprising means for individual users to create personal profiles for view by other users.

28. The personal contact and marketing system of claim 21 further comprising means for allowing a business client to send information to individual users who are identified as being interested in such information.

29. The personal contact and marketing system of claim 21 further comprising an off-line marketing means for inviting individual users to participate in the network.

30. A personal contact and marketing system for use by more than one individual user and more than one business client comprising:
one or more individual user computers, one or more business computer, at least one system server, wherein all have means for linking together using the Internet;
at least one web-site having a plurality of web-pages and residing on said server;
a computer system having a processor for implementing system software comprising a computer-readable medium having computer-readable instructions for performing a method of operating the system and wherein said computer system is linked to said server to permit individual users and business clients to communicate, and wherein said software provides a web-based interactive, menu and event driven system that cooperates with the server for providing the web-pages with prompt, dialog, and entry windows to guide a user to different said web-pages for entering information and for directing said processor to receive said information and to transmit information in real-time to at least one individual user and to at least one business client;
wherein one of said web-pages provides individual users with an interactive calendar for use by individual users to list events thereon;
wherein said computer system further comprising means for storing information about business clients, for storing information about events, and for storing statistical information;
wherein said computer system further comprising means for storing information about individual users, for identifying an individual user and storing information identifying businesses of interest to said individual user, and for storing information identifying events of interest to the identified individual user;
wherein said computer system operates to track and store statistical data in at least one of said a data bank and can be accesses by business clients through one or more of said web pages;
wherein said statistical data includes the number of times each of at least one of said web-site is accessed by the individual users, the number of new individual users joining the network and how each of the new individual users joined the network, and for each business client the particular venues and events the individual users have identified of being of interest, the number of “friends” contacted by the individual users, the venue and event information forwarded by the individual users, the events that the individual users expect to attend, the number of invitations to friends made by individual users, and the events attended by individual users.

31. The personal contact and marketing system of claim 30 further comprising means for allowing individual users to form communities within the network and message other users within said community.

32. The personal contact and marketing system of claim 31 further comprising means for allowing individual users to invite other individual users within a community to participate in a social activity.

33. The personal contact and marketing system of claim 30 further comprising means for individual users to acknowledge their intent to participate in a social activity to other individual users.

34. The personal contact and marketing system of claim 30 further comprising means for individual users to create personal profiles for view by other users.

35. The personal contact and marketing system of claim 30 further comprising means for allowing a business client to send information to individual users who are identified as being interested in such information.

36. The personal contact and marketing system of claim 30 further comprising an off-line marketing means for inviting individual users to participate in the network.

37. A method of providing a personal contact and marketing system, the method comprising:
providing a computer system having a processor and a computer-readable medium having computer-readable instructions for performing a method of operating the system and wherein said computer is linked to more than one input/output device to permit each individual user and each business client to communicate, and wherein said computer-readable medium when executed by said processor directs the processor to receive information and to transmit information in real-time to at least one individual user and to at least one business client;
providing means for each business client to store venue and event information relating to the business client;
providing means for each individual user to store information about the individual user;
providing means for linking the means for each business client to store venue and event information relating to the business client with the means for each individual user to store information about the individual user such that each individual user can have access to venue and event information relating to each business client and each business client can have access to information about each individual user.

38. The method of providing a personal contact and marketing system of claim 37 further comprising providing an interactive communications interface having an interactive calendar on which at least one individual user can schedule activities.

39. The method of providing a personal contact and marketing system of claim 37 further comprising providing an interactive communications interface having means for posting messages by the individual users.

40. The method of providing a personal contact and marketing system of claim 37 further comprising providing means for generating statistical data.

41. The method of providing a personal contact and marketing system of claim 40 wherein said means for generating statistical data includes a conventional web-site tracking means effective for tracking and storing the number of times the system web-site is accessed by a user.
